(19) United States
(12) Patent Application Publication
(10) Pub. No.: US 2026/0312356 A1
(43) Pub. Date: Oct. 8, 2026

(54) OPTICAL FIBRE AND OPTICAL FIBRE DEVICE

(71) Applicant: TRUMPF Laser UK Limited, Southampton (GB)

(72) Inventor: Andrew Malinowski, Southampton (GB)

(21) Appl. No.: 19/474,043

(22) PCT Filed: Apr. 10, 2024
(86) PCT No.: PCT/EP2024/059733

§ 371 Date: Oct. 9, 2025

(30) Foreign Application Priority Data
Apr. 14, 2023 (GB) 2305500.7
Jan. 24, 2024 (GB) 2400926.8

(51) Int. Cl. H01S 3/067

(52) U.S. Cl. CPC H01S 3/06737

(57) ABSTRACT

An optical fibre (10) comprising at least one first core (2) and at least one second core (12), wherein: the first core (2) comprises at least one active dopant (9); the first core (2) and the second core (12) are separated by a first cladding (3); the first cladding (3) has a first refractive index (5) which is less than a refractive index (4) of the first core (2) and less than a refractive index (14) of the second core (12); the optical fibre (10) being characterized in that: when the optical fibre (10) is configured in a straight line or with a uniform bend radius, first optical modes (101) having a first propagation constant β₁ can propagate along the second core (12) but are isolated from the active dopant (9); and when the optical fibre (10) is subject to a perturbation (29), the first optical modes (101) can be coupled to second optical modes (102) having a second propagation constant β₂ and which overlap the active dopant (9); thereby enabling control over at least one of a fractional inversion of the active dopant (9) along the optical fibre (10), and optical gain characteristic of the optical fibre (10), and a thermal load on the optical fibre (10), by propagating pump radiation along the second core (12) as the first optical modes (101), electively coupling the first optical modes (101) to the second optical modes (102) with one or more of the perturbations (29), and absorbing the pump radiation that has been electively coupled to the second optical modes (102) with the active dopant (9), which active dopant (9) is able to amplify by stimulated emission one or more signal modes (31) that are guided by the first core (2).

### FIELD OF INVENTION

This invention relates to an optical fibre and an optical fibre device. The invention has application for increasing the pulse energy available from a fibre laser. The invention has application for lasers used for cleaning, cutting and welding.

### BACKGROUND TO THE INVENTION

Industrial fibre lasers have important applications for cleaning, marking, cutting, scribing, welding, sintering metal powders with lasers in a process commonly referred to as additive manufacturing or 3D printing, and other industrial processing of materials. The lasers are used in many industries including consumer electronics, medical devices, automotive, and aerospace. The lasers can be pulsed or continuous wave.

High pulse energies require fibres having high saturation energies. This requires a large core, and a low emission cross section at the emission wavelength. In addition, it is desirable if the gain peak of the laser is as close as possible to the emission wavelength to avoid parasitic amplified spontaneous emission and parasitic lasing.

High average powers in fibre lasers are typically achieved by cladding pumping. The pump radiation is launched into the cladding that surrounds the core. The pump radiation overlaps with the core and can be absorbed by the active ions in the core.

As the core size is made larger to achieve higher pulse energies, absorption of the pump radiation in the core tends to become higher. High pump absorption implies high inversion near the launch point of the pump radiation which shifts the gain peak of the laser to shorter wavelengths where the emission cross-section may be larger. This can cause parasitic amplified spontaneous emission, parasitic lasing, and can also reduce the maximum pulse energy available from the laser. In addition, higher inversion also increases the tendency of the core to photodarken, a well known cause of degradation of laser performance. A higher pump absorption coefficient can also increase the thermal load of the fibre near the pump launch point which can damage the fibre. Typical coating materials used on optical fibres have a limited temperature range and will degrade if stored or operated above this range. If the pump absorption coefficient is high, then the temperature range may be exceeded even if measures are taken to maximise heat extraction, such as placing the fibre in a metal groove on a cooled plate.

For at least the foregoing reasons, it is desirable to reduce the pump absorption per unit length of fibre as the core size is increased. There are known ways to achieve this, but they have distinct disadvantages.

The most straightforward method is to increase the cladding size to maintain the ratio of cladding area to core area. However, above a certain core size, this cannot be achieved while keeping the diameter of the optical fibre sufficiently small that the fibre is flexible enough to be packaged and coiled into a spool. A 2 mm glass diameter optical fibre is more like a glass rod than a fibre.

Pump absorption can also be reduced by decreasing the concentration of active dopant. However, this does not change the fractional inversion of the active dopant, which is governed by pump intensity and absorption cross-section only. Since it is the fractional inversion that determines emission characteristics, this solution does not deliver the crucial benefit of shifting the gain peak of the fibre closer to the emission wavelength.

Pump absorption can be reduced by using a different pump wavelength, with a lower pump absorption cross-section. However, this is not in general convenient. For example, moving to a shorter wavelength will increase the quantum defect (difference in energy of pump and signal photons) reduce the efficiency of the laser, and thus increase the heat generated by the laser for the same output power. There may be no efficient pump source at the desired wavelength, or it may be achievable, but at significant increase in complexity and cost, such as in tandem pumped schemes used to pump fibre lasers near 1 μm. Cost and power efficiency are crucial parameters for industrial laser systems.

There is a need for an optical fibre and optical fibre device that allows pump absorption to be adjusted by some means other than fibre size, doping concentration or pump wavelength.

### The Invention

According to a non-limiting embodiment of the present invention there is provided an optical fibre comprising at least one first core and at least one second core, wherein:
the first core comprises at least one active dopant;
the first core and the second core are separated by a first cladding;
the first cladding has a first refractive index which is less than a refractive index of
the first core and less than a refractive index of the second core;
   the optical fibre being characterized in that:
when the optical fibre is configured in a straight line or with a uniform bend radius, first optical modes having a first propagation constant 31 can propagate along the second core but are isolated from the active dopant; and
when the optical fibre is subject to a perturbation, the first optical modes can be coupled to second optical modes having a second propagation constant β2 and which overlap the active dopant;
   thereby enabling control over at least one of a fractional inversion of the active dopant along the optical fibre, an optical gain characteristic of the optical fibre, and a thermal load on the optical fibre, by propagating pump radiation along the second core as the first optical modes, electively coupling the first optical modes to the second optical modes with one or more of the perturbations, and absorbing the pump radiation that has been electively coupled to the second optical modes with the active dopant, which active dopant is able to amplify by stimulated emission one or more signal modes that are guided by the first core.

The optical gain characteristic may be the wavelength dependence of the optical gain, or a variation in the amplitude or wavelength distribution of the amplified spontaneous emission.

The optical fibre can be used in an amplifying optical device, such as a fibre laser or an optical amplifier, in which pump radiation is coupled into the second core. The inclusion of the first cladding together with the perturbations, allows the proportion of the pump radiation that overlaps the active dopant in the first core to be controlled as a function of distance along the fibre by design. This leads in turn to the ability to control the fractional inversion of the laser, increase the pulse energy of pulses emitted by the laser, reduce the amplified spontaneous emission emitted by the laser, and reduce the thermal or heat load of the optical fibre. It also provides the ability to vary the pump absorption coefficient as a function of distance along the fibre, for example, to reduce the absorption coefficient nearest the pump launch where the pump intensity is highest, and thus distribute the heat load better.

The perturbation may comprise a spatial frequency component Λ=(β₁−β₂)/2π.

The perturbation may comprise at least one spatial frequency component that couples at least some of the first optical modes together.

The perturbation may comprise spatial frequencies other than those that couple the signal modes together.

The perturbation may comprise at least one of a change in bend radius, a change in bend orientation, a squeezing force, a long period grating, a change in a diameter of the optical fibre, a change in a cross-sectional shape of the optical fibre, a rotation of the optical fibre, and a change in material composition of the optical fibre along its length.

The active dopant may be selected from the group comprising ytterbium, erbium, neodymium, praseodymium, thulium, samarium, holmium, dysprosium, a transition metal, or a semiconductor. The active dopant may be erbium co-doped with ytterbium.

The first optical modes that propagate along the second core do not overlap the first core because of the presence of the first cladding. The first cladding acts as a barrier which allows only the second optical modes and not the first optical modes to overlap with the core. For light which begins in one of the first optical modes to overlap the first core, it must first be coupled to one of the second optical modes by the perturbation. The proportion of power that is coupled between the modes per unit length is greater for the stronger perturbation than for the weaker perturbation. Examples of stronger perturbations include larger changes in bend radii, larger changes in bend orientation, and stronger squeezing forces. The first cladding acts as a barrier layer limiting the coupling of the first and the second optical modes unless the optical fibre is perturbed with a perturbation that comprises a spatial frequency component:

$$Λ = ( {β}_{1} - {β}_{2} ) / {2}_{T T} .$$

The amount of coupling can therefore be controlled by selecting one or more of the strength of the perturbations, the number of the perturbations, and the disposition of the perturbations along the optical fibre.

It is noted that to increase the pulse energy of the laser output, the diameter of the first core needs to be increased. Without the first cladding being present, this requires the size of the second core to be increased as well. As the required pulse energies become greater than 10 mJ, the overall diameter of the fibre rapidly becomes over 1 mm, which makes the fibre difficult to package, cleave, splice, and heat sink. The inclusion of the first cladding that separates the first core from the second core reduces the effective brightness of the pump radiation overlapping with the second core. That is, the same amount of pump radiation travels along a smaller second core, but depending on the strength, number, and disposition of the perturbations, a lower proportion of the pump radiation can be made to overlap the active dopant in the first core.

Optical rays making an angle with the axis of the fibre that is less than a minimum divergence angle are confined to (guided by) the second core against the first cladding, whilst certain rays having a higher divergence angle can propagate along the second core, the first cladding and the first core, and can overlap and be absorbed by the active dopant. The rate of absorption of the pump radiation can therefore be lower in a fibre having the first cladding than one without the first cladding. The inclusion of the first cladding enables the optical fibre to have a smaller diameter than an equivalent fibre that provides the same output power and pulse energies. It also enables the optical fibre to operate at lower temperatures, thus improving the reliability of fibre coatings.

The higher-divergence pump radiation that overlaps the first core can be absorbed by the active dopant, and the amount of pump radiation that overlaps with the active dopant in the first core will therefore be reduced. There can still be plenty of pump radiation guided by the second core, however the first cladding prevents this pump radiation from overlapping and being absorbed by the active dopant. The pumping of the active dopant by the pump radiation can therefore be suppressed compared to a fibre that does not have the first cladding.

In order to maintain sufficient absorption along the length of the fibre, a mechanism to replenish the higher-divergent pump radiation is required. This replenishment is achieved by the application of perturbations to the fibre at various points along its length, which transfer lower divergent pump radiation guided by the second core to higher divergent pump radiation that can overlap the active dopant. The perturbations may be achieved by a variety of means including changes in bend radii or bend orientation, squeezing or stressing the optical fibre for example with mechanical gratings, changes in the diameter of the optical fibre, long period gratings, rotations of the fibre, changes of fibre shape for example by localized milling of the second core by a carbon dioxide laser, or changes in the material composition of the second core along the length of the optical fibre.

The combination of suppressed pump overlap with the first core due to the presence of the first cladding and the controlled increase in pump overlap with the first core via designed perturbations of the fibre allows selection by design of the rate of pump absorption along the fibre. The rate of pump absorption may be more than two times lower, preferably more than three times lower, and more preferably more than five times lower than that which would occur in the absence of the first cladding. The rate of pump radiation that is absorbed per unit length of fibre may be independently controlled in different sections of the fibre by the design of the strength of the perturbations. A stronger perturbation (for example, a tighter bend, stronger squeezing forces, stronger long period grating) will couple more pump radiation, and thus increase the rate of pump radiation that is absorbed in the following section of fibre.

The ability to control the amount of pump radiation that is coupled from the second core to the first core enables large amounts of energy to be stored in the active dopant without incurring excessive amplified spontaneous emission and parasitic lasing. This is because the rate of pump absorption along the optical fibre can be reduced by preventing the pump radiation from coupling out of the second core, and thus much higher levels of pump radiation and longer lengths of the optical fibre can be used. As shown below, the invention enables nanosecond laser sources having pulse energies greater than 100 mJ. Such lasers are difficult to design without having very large fibre diameters which, due to the extremely strong dependence of fibre stiffness on diameter, are impractical to package in a module of reasonable size because of the very large bend radii required to avoid the fibre breaking.

The optical fibre may comprise a plurality of the first cores.

The optical fibre may comprise a plurality of the second cores.

The second core may be non-circular.

The optical fibre may comprise a second cladding. The second cladding may surround the second core. The second core may have a second refractive index that is less the first refractive index.

The second cladding may be non-circular.

The first core and the second core may be surrounded by the second cladding.

The second cladding may be a polymer. The first core and the second core may be separable from each other. This may be achieved by removing the second cladding from at least part of the optical fibre for example using a chemical, heat, or mechanically. Advantageously, this allows the first core to be spliced to a signal input fibre, and the second core to be spliced to a pump fibre.

The optical fibre may include a pump fibre that is in optical contact with the second core along its length. The second core may surround the first core. The second core and the pump fibre may be surrounded by the second cladding.

The second cladding may be a polymer. The optical fibre may be characterized in that the pump fibre and the second core are separable from each other.

At least one of the first and the second cores may be a ring core.

A width of the first core may be greater than 50 μm, preferably greater than 100 μm, and more preferably greater than 250 μm.

The width of the first cladding may be greater than 5 μm, preferably greater than 10 μm and more preferably greater than 15 μm.

A width of the second core may be greater than 50 μm, preferably greater than 100 μm and more preferably greater than 150 μm.

The refractive index of the second core may be greater than 0.001, preferably greater than 0.004, and more preferably greater than 0.01 than the first refractive index of the first cladding.

The refractive index of the first core may be greater than the refractive index of the second core. The refractive index of the first core may be greater than 0.015 than the first refractive index of the first cladding.

The active dopant may be uniformly distributed across the first core. Alternatively, the active dopant may be concentrated more within the centre of the first core than at its edges. This may improve the beam quality of stimulated laser radiation emitted from the optical fibre.

The invention also provides an optical fibre spool comprising an optical fibre of the invention. The optical fibre spool may include a plurality of the perturbations.

The perturbation may comprise a change in bend radius.

The perturbation may comprise a long period grating.

The optical fibre may be disposed in a groove.

The second core of the optical fibre may have a width less than 1 mm, preferably less than 0.9 mm, and more preferably less than 0.8 mm.

The optical fibre spool may be characterized by a minimum bend radius less than 20 mm, preferably less than 15 mm, and more preferably less than 10 mm.

The optical fibre spool may be characterized by a cross-sectional width less than 500 mm, preferably less than 400 mm, and more preferably less than 300 mm.

The invention also provides an amplifying optical device for emitting an output signal at a signal wavelength comprising an optical fibre spool according to the invention and at least one pump source. The pump source may be connected to the second core to allow pump radiation from the pump source to be guided by the second core, and to be coupled to the active dopant by the perturbation. The output signal may comprise stimulated emission emitted from the active dopant. The stimulated emission is preferably guided by the first core. More than one pump sources may be provided, which may emit at the same wavelength or at different wavelengths.

The optical fibre may be characterized by a temperature rise above a temperature of a baseplate. The strength and disposition of the perturbations may be such that when the optical fibre is pumped by the pump source, the temperature rise is less than 100° C., preferably less than 70° C., and more preferably less than 50° C.

The amplifying optical device may have a fractional inversion of the active dopant along at least 70% of the length of the optical fibre is less than 10%, preferably less than 8%, and is more preferably equal to 7%.

The first core may be characterized by an absorption length at a pump wavelength. The first core has a first core area and the second core has a second core area. The optical fibre may be characterized by a ratio of core areas equal to the sum of the first and the second core areas divided by the first core area. The length of the optical fibre may be at least two times longer, preferably at least three times longer, and more preferably at least five times longer than the product of the absorption length and the ratio of the core areas.

The optical fibre may have a fibre length that is at least twice a length of an equivalent optical fibre that has no first cladding and which is optionally used with the amplifying optical device while absorbing the same amount of pump radiation along its length, wherein the first cladding of the optical fibre is replaced in the equivalent optical fibre by a region having the same refractive index as the refractive index of the second core of the optical fibre, thus enabling the second core of the equivalent fibre to act as a pump cladding that surrounds the first core.

The amplifying optical device may be characterized by a pulse energy. The strength and disposition of the perturbations may be such that when the optical fibre is pumped by the pump source, the pulse energy is higher than when the amplifying optical device uses the equivalent optical fibre.

The amplifying optical device may be characterized by a gain peak and a gain peak wavelength. The strength and disposition of the perturbations may be such that when the optical fibre is pumped by the pump source, the gain peak wavelength is at a longer wavelength than when the amplifying optical device uses the equivalent optical fibre. The gain peak may have a higher gain when the amplifying optical device uses the optical fibre than when the amplifying optical device uses the equivalent optical fibre.

The amplifying optical device may include more than one pump. One of the pumps may emit the pump radiation at a different pump wavelength than another one of the pumps.

The active dopant may comprise ytterbium ions, and the gain peak may be at 1060 nm.

The active dopant may comprise erbium or erbium co-doped with ytterbium, and the gain peak wavelength may be in the range 1555 nm to 1650 nm.

The active dopant may comprise holmium, and the gain peak wavelength may be in the range 1990 nm to 2150 nm. The amplifying optical device may include more than one pump. One of the pumps may emit the pump radiation at 915 nm. The other pump may emit the pump radiation at 976 nm.

The active dopant (9) may comprise thulium, and the gain peak wavelength may be in the range 1900 nm to 2100 nm. Advantageously, thulium ions may be pumped at 793 nm.

A difference between the signal wavelength and the gain peak wavelength may be less than 10 nm, preferably less than 5 nm, and more preferably less than 1 nm.

The amplifying optical device may be configured such that more than 1 kW, preferably more than 2 kW, and more preferably more than 3 kW of pump radiation is guided by the second core.

The amplifying optical device may include a seed laser connected to the first core to allow signal energy to be guided by the first core and to be amplified along the optical fibre.

The seed laser may be a pulsed laser.

The seed laser may be able to emit signal pulses having pulse widths between 100 ps and 10 ms, and the amplifying optical device is configured to emit individual pulse energies greater than 50 mJ, preferably greater than 100 mJ, and more preferably greater than 200 mJ.

The amplifying optical device may comprise an optical feedback arrangement configured to promote light generation within the optical fibre to produce a laser.

The amplifying optical device may comprise at least one reflecting device configured to reflect optical energy back into the first core.

The amplifying optical device may comprise an optical switch connected to the first core.

The invention also provides a method for providing optical radiation, which method comprises:
providing an optical fibre comprising at least one first core and at least one second core, wherein the first core comprises at least one active dopant; the first core and the second core are separated by a first cladding; and the first cladding has a first refractive index which is less than a refractive index of the first core and less than a refractive index of the second core;
propagating pump radiation along the second core in the form of first optical modes having a first propagation constant β₁;
selecting a strength and disposition of at least one perturbation;
perturbing the optical fibre with the at least one perturbation to couple the pump radiation from the second core to second optical modes having a second propagation constant 32 and which overlap the active dopant;
absorbing the pump radiation with the active dopant;
propagating one or more signal mode along the first core;
amplifying the signal mode with the active dopant by stimulated emission; and
outputting the amplified signal modes in the form of the optical radiation;
   the method being characterized in that:
when the optical fibre is configured in a straight line or with a uniform bend radius, the first optical modes can propagate along the second core but are isolated from the active dopant.

The method may include the step of controlling at least one of a fractional inversion of the active dopant along the optical fibre, an optical gain characteristic of the optical fibre, and a thermal load on the optical fibre. This can be achieved by selecting the strength and disposition of the perturbation.

The perturbation comprises a spatial frequency component

$$Λ = ( {β}_{1} - {β}_{2} ) / {2}_{T T} .$$

The perturbation comprises at least one spatial frequency component that couples at least some of the first optical modes together.

The perturbation comprises spatial frequencies other than those that couple the signal modes together.

The perturbation comprises at least one of a change in bend radius, a change in bend orientation, a squeezing force, a long period grating, a change in a diameter of the optical fibre, a change in a cross-sectional shape of the optical fibre, a rotation of the optical fibre, and a change in material composition of the optical fibre along its length.

The method may include the step of providing the signal modes by coupling signal radiation from a seed laser into the first core.

The method may include the step of providing an optical feedback arrangement to promote light generation within the optical fibre to produce a laser. The optical feedback arrangement may comprise at least one reflecting device configured to reflect optical energy back into the first core. The reflecting device may comprise an optical fibre Bragg grating.

The method may include the step of providing an optical switch and connecting the optical switch to the first core.

The method of the invention may include a step or steps as required to utilize the above mentioned optional aspects of the optical fibre, the optical fibre spool, or the amplifying optical device of the invention.

### BRIEF DESCRIPTION OF THE DRAWINGS

Embodiments of the invention will now be described solely by way of example and with reference to the accompanying drawings in which:

FIG. 1 shows an optical fibre according to the present invention;

FIG. 2 shows an optical ray being coupled from the second core, being absorbed by an active dopant, and emitting a ray that is guided by the first core;

FIG. 3 shows groups of optical modes that are guided by the optical fibre;

FIG. 4 shows an optical fibre having a non-circular second core;

FIG. 5 shows an optical fibre having a non-circular second cladding;

FIG. 6 shown an optical fibre having four second cores disposed in the second cladding;

FIG. 7 shown an optical fibre having four second cores disposed in the first cladding;

FIG. 8 shows an optical fibre having four first cores and three second cores, which first and second cores are disposed in the first cladding;

FIG. 9 shows an optical fibre having three first cores disposed in the second core, which first cores are each surrounded by a first cladding;

FIG. 10 shows an optical fibre in which the second core is surrounded by the first cladding, and the first cladding is surrounded by the first core;

FIG. 11 shows an optical fibre wherein the first cladding surrounds the first core, and wherein the first core and the first cladding are separable from the second core by removing the second cladding and pulling;

FIG. 12 shows an optical fibre wherein the first cladding surrounds the second core, and wherein the first core is separable from the second core and the first cladding by removing the second cladding and pulling;

FIG. 13 shows an optical fibre and including a separate pump fibre, wherein the pump fibre is separable from the second core by removing the second cladding and pulling;

FIG. 14 shows an optical amplifier comprising an optical fibre according to the present invention, the optical fibre is end pumped, and the amplifier is incorporated as the power amplifier in a master oscillator power amplifier;

FIG. 15 shows a bundle of pump fibres and a signal fibre within a capillary that forms part of an output combiner;

FIG. 16 shows a combiner fibre that may be spliced to the bundle of fibres of FIG. 15;

FIG. 17 shows a spool of optical fibre configured in a flat spiral having straight edges and rounded corners;

FIG. 18 shows the optical fibre of the present invention wound onto a spool former;

FIG. 19 shows the optical fibre of the present invention in which the perturbations that couple pump radiation from modes guided by the second core to other modes that overlap the active dopant is provided by a long period grating;

FIG. 20 shows a laser comprising the optical fibre of FIG. 4;

FIG. 21 shows a laser comprising the optical fibre of FIG. 13;

FIG. 22 shows a master oscillator power amplifier comprising the optical fibre of FIG. 11;

FIG. 23 shows a master oscillator power amplifier comprising two amplifiers and the amplifier of FIG. 14;

FIG. 24 shows a Q-switched laser comprising the amplifier of FIG. 14;

FIG. 25 shows the absorption and emission cross-sections versus wavelength for ytterbium ions in the ytterbium-doped optical fibres used in Examples 1-6;

FIGS. 26 and 27 show fractional inversion against fibre length for Examples 1-6;

FIGS. 28 and 29 show pump absorption against fibre length for Examples 1-6;

FIG. 30 shows spectra of amplified spontaneous emission for Examples 1, 3, 4, 5 and 6;

FIG. 31 shows the optical fibre used in Example 1; and

FIG. 32 shows an equivalent optical fibre not according to the invention that does not have the first cladding.

### DETAILED DESCRIPTION OF PREFERRED EMBODIMENTS OF THE INVENTION

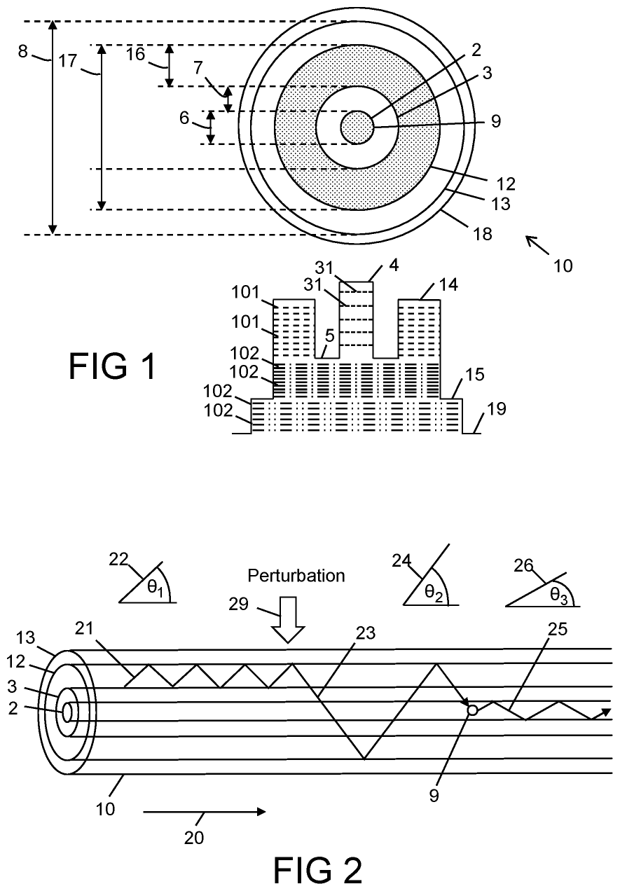

FIG. 1 shows an optical fibre 10 comprising at least one first core 2 and at least one second core 12, wherein:
the first core 2 comprises at least one active dopant 9;
the first core 2 and the second core 12 are separated by a first cladding 3;
the first cladding 3 has a first refractive index 5 which is less than a refractive index 4 of the first core 2 and less than a refractive index 14 of the second core 12; and
   the optical fibre 10 being characterized in that:
when the optical fibre 10 is configured in a straight line or with a uniform bend radius, first optical modes 101 having a first propagation constant β₁ can propagate along the second core 12 but are isolated from the active dopant 9; and
when the optical fibre 10 is subject to a perturbation 29, shown with reference to FIG. 2, the first optical modes 101 can be coupled to second optical modes 102 having a second propagation constant 32 and which overlap the active dopant 9;
   thereby enabling control over at least one of a fractional inversion of the active dopant 9 along the optical fibre 10, an optical gain characteristic of the optical fibre 10, and a thermal load on the optical fibre 10, by propagating pump radiation along the second core 12 as the first optical modes 101, electively coupling the first optical modes 101 to the second optical modes 102 with one or more of the perturbations 29, and absorbing the pump radiation that has been electively coupled to the second optical modes 102 with the active dopant 9, which active dopant 9 is able to amplify by stimulated emission one or more signal modes 31 that are guided by the first core 2.

The coupling from the first optical mode 101 to the second optical mode 102 may be direct or indirect. An example of indirect coupling is where the perturbation 29 couples the first optical mode 101 to a skew mode that does not overlap the active dopant 9. Additional coupling, either by one of the perturbations, another perturbation, or via asymmetry designed into the optical fibre 10, may couple the skew mode to the second optical mode 102 that does overlap the active dopant 9.

The perturbation 29 may comprise at least one of a change in bend radius, a change in bend orientation, a squeezing force, a long period grating, a change in a diameter of the optical fibre 10, a change in a cross-sectional shape of the optical fibre 10, a rotation of the optical fibre 10, and a change in material composition of the optical fibre 10 along its length.

The active dopant 9 may be selected from the group comprising ytterbium, erbium, neodymium, praseodymium, thulium, samarium, holmium, and dysprosium. Alternatively, or additionally, the active dopant may be a transition metal or a semiconductor. More than one active dopant 9 may be selected. For example, the active dopant 9 may comprise erbium co-doped with ytterbium.

The optical gain characteristic may be the wavelength dependence of the optical gain, or a variation in the amplitude or wavelength distribution of the amplified spontaneous emission.

In rare-earth doped fibre amplifiers, the upper and lower energy levels of the active dopant 9 comprise a large number of slightly different energy levels which are strongly coupled together, and consequently population inversion in the sense of >50% inversion is not required for obtaining optical amplification. For longer wavelengths where the emission is typically much stronger than the absorption, gain may be achieved even for low excitation levels. For this reason, the fractional inversion N, that is the fraction of ions or atoms of the active dopant 9 that are in an excited state compared to those in a lower energy state, is used to model the fibres. It is the fractional inversion that allows for light amplification by stimulated emission, the higher the fractional inversion, the higher the optical gain. Higher fractional inversion also leads to higher levels of spontaneous emission as the active dopant 9 relaxes to a lower energy state by emitting a photon. High optical gain combined with high levels of spontaneous emission leads to higher levels of amplified spontaneous emission (ASE) which is generally undesirable as it reduces the amount of gain available to the signal, and ASE is usually an unwanted output signal.

Optical gain g in an optical amplifier is determined by the fractional inversion and the (wavelength dependent) emission and absorption cross-sections.

$$g = {N}_{0} ( {N σ}_{e m} - ( 1 - N ) {σ}_{abs} )$$

where N₀ is the dopant concentration of the active dopant, N is fractional inversion of the active dopant, and σₑₘ and σ_{abs} are the emission and absorption cross-sections at the emitted wavelength.

As energy is extracted from the amplifier the fractional inversion falls, and therefore so does the gain. The saturation energy Eₛₐₜ of a laser gain medium is the pulse energy of an incident signal pulse which leads to a reduction in the gain to 1/e² (≈37%) of its initial value.

$${E}_{sat} = \frac{A hv}{{σ}_{em} + {σ}_{abs}}$$

where for a highly multimode fibre, A is area of the core containing the active dopant 9, and hv is photon energy (determined by the wavelength of the emitted light).

The highest possible pulse energy (for a very long pulse) extractable from an optical amplifier is typically taken to be approximately ten times the saturation energy, but for pulses having 100-1000 ns pulse widths, the practical limit is closer to 3 or 4 times the saturation energy.

For a ytterbium doped fibre, the emission cross section gem is approximately three times greater at 1030 than at 1065 nm, whereas the absorption cross section Cabs IS considerably smaller than σₑₘ at both wavelengths, meaning that the saturation energy Eₛₐₜ is about three times larger for a 1065 nm signal compared to a 1030 nm signal. It is therefore desirable to operate with a signal at 1065 nm if maximising pulse energy is important.

The gain peak wavelength is the wavelength of light which experiences the highest gain when passing through the amplifier. As can be deduced from the equation for g, the gain peak wavelength will depend on both the cross-sections and the inversion, and can therefore be controlled by controlling the pump absorption along the fibre. The inversion may vary along the length of the amplifier and with time. The gain peak wavelength is therefore usually applied to the time-averaged gain integrated along the whole length of the amplifier.

Amplified spontaneous emission ASE is light with broad bandwidth which arises from random spontaneous emission within the amplifier. The spontaneous emission experiences optical gain in the same way as deliberately introduced light signals. Because the initial input is broadband and different wavelengths experience different gain, the spectrum of the ASE at the output of the amplifier will typically be maximum at or near to the gain peak wavelength of the amplifier.

Unlike the signal, which may be pulsed, ASE is emitted at all times that the amplifier is pumped. If the signal is at a wavelength away from the gain peak wavelength, it will experience lower gain than the ASE, which leads to the ASE representing an increased proportion of the total output of the amplifier. For highest efficiency in generating pulses (and lowest light levels in between pulses) the signal preferably has a wavelength close to the gain peak wavelength. The difference between the signal wavelength and the gain peak wavelength can be less than 10 nm, preferably less than 5 nm, and more preferably less than 1 nm.

The optical fibre 10 shown in FIG. 1 can be used in a fibre laser or optical amplifier in which pump radiation is coupled into the second core 12. It is noted that to increase the pulse energy of the laser output, the diameter 6 of the first core 2 needs to be increased. Without the first cladding 3 being present, this requires the size of the second core 12 to be increased as well. As the required pulse energies become greater than 10 mJ, the overall diameter of the fibre rapidly becomes over 1 mm, which makes the fibre difficult to package, cleave, splice, and heat sink. The inclusion of the first cladding 3 that separates the first core 2 from the second core 12 reduces the effective brightness of the pump radiation travelling along the second core 12. That is, the same amount of pump radiation travels along a smaller second core 12, but depending on the perturbations 29, a lower proportion of the pump radiation can be made to overlap the active dopant 9. The rate of absorption of the pump radiation can therefore be lower. The inclusion of the first cladding 3 enables the optical fibre 10 to have a smaller diameter than an equivalent fibre that provides the same output power and pulse energies. It also enables the optical fibre 10 to operate at lower temperatures, thus improving the reliability of fibre coatings.

The ability to control the amount of pump radiation that is coupled from the second core 12 to the first core 2 enables large amounts of energy to be stored in the active dopant 9 without incurring excessive amplified spontaneous emission and parasitic lasing. As shown below, the invention enables nanosecond laser sources having pulse energies greater than 100 mJ. Such lasers are difficult to design without having very large fibre diameters which, due to the extremely strong dependence of fibre stiffness on diameter, are impractical to package in a module of reasonable size because of the very large bend radii required to avoid the optical fibre 10 breaking.

The optical fibre 10 may comprise a second cladding 13 having a second refractive index 15 that is less than the refractive index 14 of the second core 12. The second refractive index 15 is preferably less than the first refractive index 5 of the first cladding 3. The second cladding 13 may be glass or a polymer coating. The second cladding 13 may also be air or a vacuum, both of which have a refractive index of 1 and can be treated as a cladding in waveguide theory. Without the second cladding 13, the optical modes propagating in the second core 12 may leak away.

The first core 2 can form part of a signal waveguide which may comprise additional cores and claddings. The first core 2 can be located along the central axis of the optical fibre 10 or may be offset from the central axis. The second core 12 can form part of a pump waveguide which may comprise additional cores and claddings.

The optical fibre 10 may also comprise an optional third cladding 18 having a third refractive index 19. The third cladding 18 may be glass or a polymer coating. The third cladding 18 may also be air or a vacuum, both of which have a refractive index of 1 and can be treated as a cladding in waveguide theory.

The first refractive index 5 may be greater than the second refractive index 15. The first refractive index 5 may be smaller than the second refractive index 15 and greater than the third refractive index 19.

Optical modes of multimode waveguides can be modelled using light rays. FIG. 2 shows the first optical mode 101 represented by a ray 21 that is propagating along the second core 12 of the optical fibre 10. The ray 21 is characterized by an angle θ₁ 22 with respect to the local longitudinal axis 20 of the optical fibre 10. The ray 21 is a low divergence ray that is totally internally reflected at the boundary between the second core 12 and the first cladding 3, and also at the boundary between the second core 12 and the second cladding 13. The ray 21 does not interact with the active dopant 9. The optical fibre 10 is perturbed, as shown by the perturbation 29. The perturbation 29 may be a change in bend radius, a squeezing force being applied, or some other form of perturbation. The perturbation 29 may couple the first optical mode 101 to the second optical mode 102 represented by the ray 23. The ray 23 is characterized by an angle θ₂ 24 with respect to the local longitudinal axis 20 of the optical fibre 10. The angle θ₂ 24 is larger than the angle θ₁ 22, and is sufficiently large that the ray 23 is not totally-internally reflected by the first cladding 3. Thus the second optical mode 102 represented by the ray 23 is not guided by the second core 12. The ray 23 shown is representative of the higher-divergence pump radiation that traverses the first core 2, and is absorbed by the active dopant 9. Spontaneous or stimulated emission from the active dopant 9 then launches the signal mode 31 represented by the ray 25 characterized by an angle θ₃ 26 with respect to the local longitudinal axis 20 of the optical fibre 10. The ray 25 is totally internally reflected at the boundary between the first core 2 and the first cladding 3, and is guided by the first core 2. The angle θ₃ 26 of the ray 25 propagating along the first core 2 is less than the angle θ₂ 24 of the ray 23 as it traverses the first core 2.

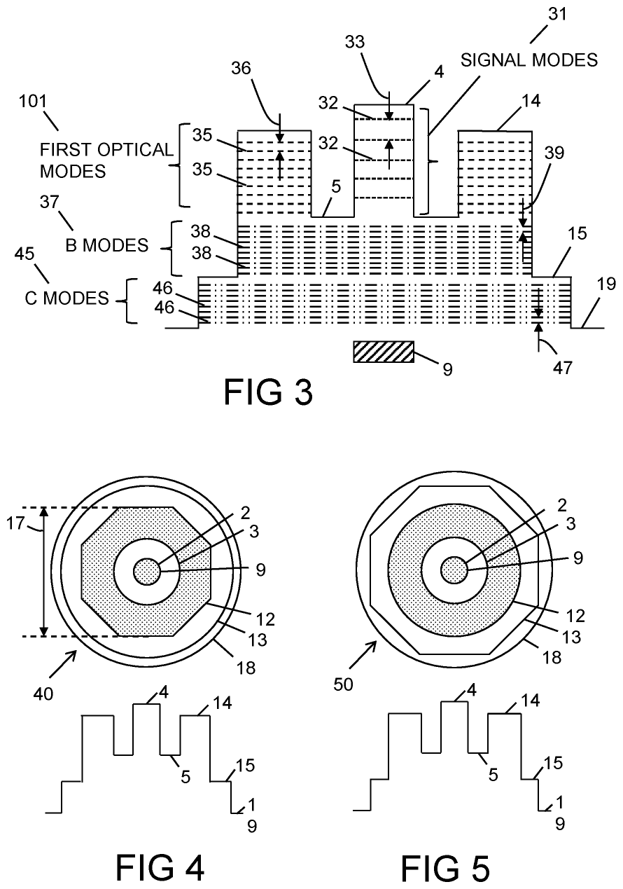

FIG. 3 shows several groups of modes that can propagate along the optical fibre 10:
“Signal modes” 31 guided by the boundary between the first core 2 and the first cladding 3. The signal modes 31 have effective refractive indices 32 between the first refractive index 5 of the first cladding 3 and the refractive index 4 of the first core 2. The signal modes 31 are shown as having effective index mode spacings 33 between different modes.
First optical modes 101 or “A modes” guided by the boundary between the second core 12 and the first and second claddings 3, 13. The first optical modes 101 have effective refractive indices 35 less than the refractive index 14 of the second core 12, and between the higher of the first refractive index 5 of the first cladding 3 and the second refractive index 15 of the second cladding 13. The first optical modes 101 are shown as having effective index mode spacings 36 between different modes.
“B modes” 37 guided by the boundary between the second core 12 and the second cladding 13. The B modes 37 have effective refractive indices 38 less than the first refractive index 5 of the first cladding 3 and higher than the second refractive index 15 of the second cladding 13. The B modes 37 are shown as having effective index mode spacings 39 between different modes. Some of the B modes 37 may be skew modes that do not overlap the active dopant 9. Thus not all of the B modes 37 are the first optical modes 101 of FIG. 1.
“C modes” 45 guided by the boundary between the second cladding 13 and the third cladding 18. The C modes 45 have effective refractive indices 46 less than the lower of the first refractive index 5 of the first cladding 3 and the second refractive index 15 of the second cladding 13. The C modes 45 are shown as having effective index mode spacings 47 between different modes. Some of the C modes 45 may be skew modes that do not overlap the active dopant 9.

The effective index mode spacings 32, 36, 39 and 47 are shown being uniform within each group of modes. In practice there will be some variation within each group.

The above description of the modes implies a core does not guide a mode when its effective index falls below the refractive index of the adjacent cladding. This phenomenon is called cut-off. At effective indices below cut-off, the mode cannot exist as a properly guided mode. However, wave propagation does not cease abruptly below cut-off. Instead, many modes can transform themselves into leaky waves that have relatively low losses and that may propagate considerable distances along the core. For the purposes of this discussion, modes that are guided by a core also include leaky modes or rays that are effectively guided by the core of the optical fibre when the optical fibre is held in a straight line. Such modes are able to be coupled to other optical modes of the optical fibre 10 that overlap the active dopant 9 when the optical fibre 10 is perturbed in a perturbation 29. By “effectively guided” it is meant that the attenuation is less than 0.1 dB/m.

If the first refractive index 5 of the first cladding 3 is higher than the second refractive index 15 of the second cladding 13 (which is the case shown in FIG. 3), the first optical modes 101 that are guided by the second core 12 may be coupled by the perturbation 29 to the B modes 37 and/or the C modes 45. Certain of the B modes 37 and C modes 45 overlap with the active dopant 9 in the first core 2 which may absorb the energy from the mode. Spontaneous or stimulated emission from the active dopant 9 may launch or amplify the signal modes 31 which are guided by the first core 2.

A perturbation can couple a first mode having a propagation constant β₁ to a second mode having a propagation constant 32 when the perturbation has a spatial frequency component Λ=(β₁−β₂)/2π=(neff₁−neff₂)/λ, where λ is the wavelength of the optical radiation, and neff₁ and neff₂ are the effective indices of the first and second modes being coupled. So for example, if the perturbation were a sinusoidal deflection of the optical fibre having a period of 1 mm, then the spatial frequency would be 1000 cycles/m. At a wavelength λ=1 μm, the perturbation would then couple modes that have a difference in their effective indices of 0.001 or 10⁻³. Power coupled that is in phase at each deflection of the optical fibre will build up along constructively its length. Similarly, if the sinusoidal deflection has a period of 10 mm, then the spatial frequency is 100 cycles/m. At a wavelength λ=1 μm, the perturbation would then couple modes that have a difference in their effective indices of 0.0001 or 10⁻⁴.

The bending stiffness of an optical fibre increases proportionally to the fourth power of its glass diameter. This means that in a reasonably large diameter fibre it is far easier to mechanically couple modes that have smaller differences in their effective indices than it is to couple modes that have larger differences in their effective indices because the latter require higher spatial frequencies in the perturbations that couple the modes. For example, if the optical fibre has a diameter of 0.5 mm, then it is easier to achieve a sinusoidal deflection having a spatial frequency of 100 cycles/m than it is to achieve the same deflection at 1000 cycles/m. The dependence of mode coupling on fibre diameter is very strong. The optical fibre acts as a low pass filter, filtering out perturbations from bending forces that have high spatial frequencies.

The dependence of mode coupling on the effective index mode spacings between different modes can be taken advantage of as shown in FIG. 3. It is preferable for the mode spacing 36 between consecutive groups of modes in the second core 12 to be less than the mode spacing 33 between consecutive groups of modes in the first core 2. This is because it is desired that the perturbation 29 couples optical radiation out of the first optical modes 101 propagating in the second core 12 to the B-modes 37. Certain of the B-modes 37 overlap with, and are absorbed by, the active dopant 9, which in turn amplifies optical radiation propagating as signal modes 31 in the first core 2 by stimulated emission. It is often preferable that the perturbation 29 does not couple the signal modes 31 to the B-modes 37 as this would result in losses and reduced efficiency. It is therefore preferred that either (i) the spacing 33 is larger than the spacing 36, and/or (ii) the spatial frequency of the perturbation is selected to couple the first optical modes 101 to the B-modes 37 in preference to the coupling of the signal modes 31 to the B-modes 37.

The average spacing between the effective indices of consecutive groups of modes is approximately inversely proportional to the width or diameter of the core. Thus the mode spacing 33 between consecutive groups of modes in the first core 2 can be designed to be larger than the mode spacing 36 between consecutive groups of modes in the second core 12 by ensuring that the first core 2 has a diameter 6 that is smaller than a diameter 17 of the second core 12. This will be the case for the optical fibre 10 shown in FIG. 1. Differences in the refractive index profiles of the first core 2 and the second core 12 can also be used to influence the difference in spacing of the effective indices of the modes.

The perturbation 29 couples or scatters the first optical modes 101 together, as well as coupling the first optical modes 101 to the B-modes 37 that overlap the active dopant 9. In order to couple the first optical modes 101 together, the length of the perturbation 29 is preferably less than the adiabatic length which is the minimum length of a perturbation required to produce negligible coupling between modes. For typical step index fibres having a core diameter 17 of 660 μm, the adiabatic length is approximately 10 mm. Thus to achieve mode coupling between the first optical modes 101, the optical fibre needs to be perturbed with bends, stresses, tapers, variations in refractive indices and/or other perturbations having longitudinal spatial frequencies less than 10 mm. This is achievable by mechanically bending the optical fibre.

The adiabatic length is approximately proportional to the width of the core. Thus the adiabatic length for a typical first core 2 of width 6 of 170 μm would be approximately 2.6 mm. It is more difficult to produce bends having a spatial frequency of component 2.6 mm in a 660 μm diameter fibre than it is to produce bends having a spatial frequency component of 10 mm. Thus the first optical modes 101 propagating in the second core 12 can be coupled together, or scattered, far more easily than the signal modes 31 propagating in the first core 2.

Similarly, if the second core diameter 17 is doubled to 1320 μm, the adiabatic length increases to approximately 20 mm, and the bending stiffness increases by a factor of 16. Such an optical fibre would be difficult to package in a spool unless the spool diameter were very large or if stress in the fibre could be released, for example by melting the glass with a flame or electric arc.

Thus the perturbation 29 can be designed to couple the first optical modes 101 to the second optical modes 102 by selecting its spatial frequency component A such that:

$$Λ = ( {β}_{1} - {β}_{2} ) / {2}_{T T} .$$

However, this will typically only couple the first optical modes 101 that have effective indices very similar to the effective indices of the second optical modes 102. It is therefore preferably for one or more of the perturbations 29 to comprise at least one spatial frequency component that couples at least some of the first optical modes 101 together.

The beam quality of the signal is usually an important parameter for a laser or an amplifier. Higher beam qualities are provided by the signal modes 31 that have the highest effective refractive indices 32. As discussed previously, the mode spacings 33 of the signal modes 31 in FIG. 3 are larger than the mode spacings 36 of the first optical modes 101. The beam quality of the signal modes 31 as they propagate along the optical fibre 10 can therefore be preserved by designing the perturbation 29 such that it comprises spatial frequencies other than those that couple the signal modes 31 together. The design parameters can be achieved theoretically as shown in Example 1, or experimentally.

The rays 23 shown in FIG. 2 are meridional rays that cross the first core 2. Many optical modes comprise skew rays that do not cross the first core 2. Skew rays or meridional rays may also not cross the first core 2 if the core is offset from the centre of the optical fibre. If the skew rays cannot be coupled to rays that cross the first core 2, then they will not overlap and cannot be absorbed by the active dopant 9. It may therefore be preferable that at least one of the first cladding 3, the second core 12, and the second cladding 13 is non-circular to encourage coupling between the skew rays and the rays that overlap the active dopant 9.

The second core 12 may be a regular or irregular polygon such as in the optical fibre 40 shown in FIG. 4 which has an octagonal second core 12. The polygon may be a Reuleaux polygon. The optical fibre 40 may comprise the optional third cladding 18. The second core 12 may have a D-shaped cross-section with one flat surface, or may have more than one flat surface. Alternatively or additionally, the second cladding 13 can be non-circular. The second cladding 13 may be a regular or irregular polygon such as in the optical fibre 50 shown in FIG. 5 which has an octagonal second cladding 13. The polygon may be a Reuleaux polygon. The second cladding 13 may have a D-shaped cross-section with one flat surface, or may have more than one flat surface. Removing the circular symmetry from the second core 12 and/or the second cladding 13 can increase coupling between the different first optical modes 101 (A to A mode coupling) and the different B modes 37 (if present) (B to B mode coupling), for example in the case of a non-circularly symmetric second core 12, and between the different C modes 45 (if present) (C to C mode coupling), for example, in the case of a non-circularly symmetric second cladding 13. Removing the circular symmetry can increase the coupling to the active dopant 9, and thus increase the efficiency of an amplifying optical device such as an optical amplifier or a laser made from the optical fibre 10.

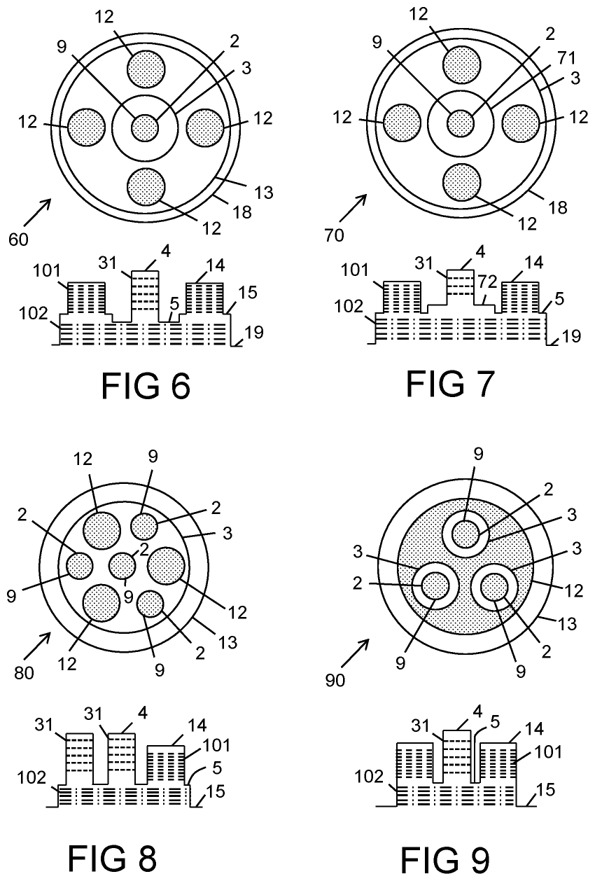

FIG. 6 shows an optical fibre 60 that has four second cores 12. The four second cores 12 are in a common second cladding 13. The first core 2 is surrounded by the first cladding 3, which is surrounded by the second cladding 13. The second refractive index 15 of the second cladding 13 is shown as being greater than the first refractive index 5 of the first cladding 3. At least one of the second cores 12 and/or the second cladding 13 may be non-circular. An optical fibre with more than one second core 12 is useful for retaining the brightness of pump radiation along the optical fibre 60. The second optical modes 102 are guided by the boundary between the second cladding 13 and the third cladding 18.

FIG. 7 shows an optical fibre 70 that has four second cores 12 in the first cladding 3. The first core 2 is surrounded by a cladding 71 which is surrounded by the first cladding 3. The cladding 71 has a refractive index 72 that is higher than the first refractive index 5 of the first cladding 3. An optical fibre with more than one second core 12 is useful for retaining the brightness of pump radiation along the optical fibre 70. The second optical modes 102 are guided by the boundary between the first cladding 3 and the third cladding 18.

FIG. 8 shows an optical fibre 80 that has four first cores 2 and three second cores 12, all of which are surrounded by the first cladding 3. The second cladding 13 surrounds the first cladding 3. The first refractive index 5 is greater than the second refractive index 15. The second optical modes 102 are guided by the boundary between the first cladding 3 and the second cladding 13.

FIG. 9 shows an optical fibre 90 that has three first cores 2, each surrounded by a first cladding 3. The three first claddings 3 are surrounded by the second core 12. The second core 12 is surrounded by the second cladding 13. The first refractive index 5 of the first cladding 3 is greater than the second refractive index 15 of the second cladding 13. The second optical modes 102 are guided by the boundary between the second core 12 and the second cladding 13.

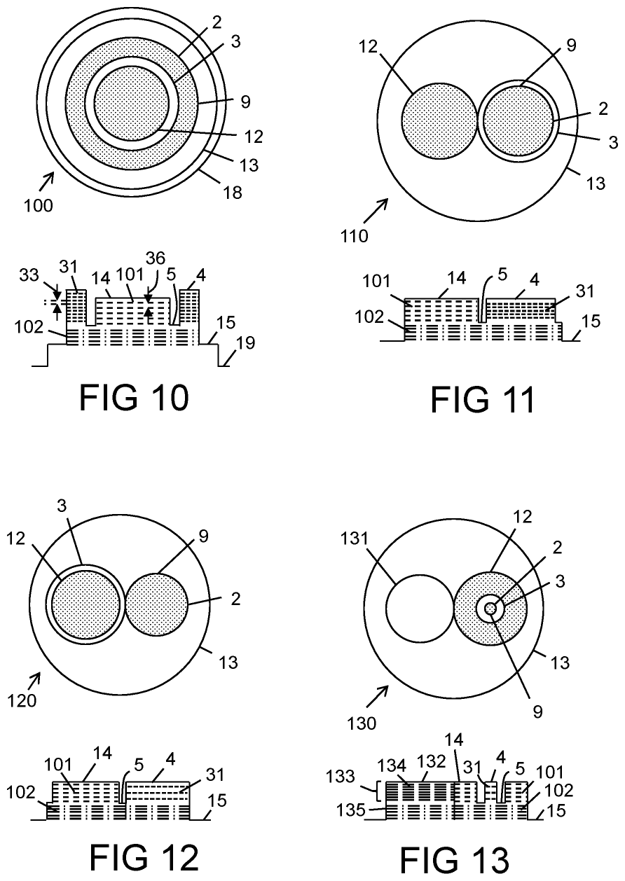

FIG. 10 shows an optical fibre 100 wherein the first core 2 is a ring core that surrounds the second core 12. The first core 2 and the second core 12 are separated by the first cladding 3. The second optical modes 102 are guided by the boundary between the first core 2 and the second cladding 13.

FIG. 11 shows an optical fibre 110 wherein the first cladding 3 and the second core 12 are surrounded by the second cladding 13. The second core 12 is preferably in optical contact with the first cladding 3 along its length. The second core 12 is shown as circular but may alternatively be non-circular. The second core 12 may have a larger cross-sectional area than the cross-sectional area of the first core 2 to enable the effective index spacings 36 of the first optical modes 101 to be smaller than the effective index spacings 32 of the signal modes 31 shown with reference to FIG. 3. The larger cross-sectional area may also enable higher optical powers to be obtainable from the first core 2. The second cladding 13 may be a polymer. The first core 2 and the second core 12 may be separable from each other by removing the second cladding 13. This enables an end of the second core 12 to be separated from the first core 2 and connected to a pump source.

FIG. 12 shows an optical fibre 120 that is similar to the optical fibre 110 of FIG. 11, save that the first cladding 3 is disposed around the second core 12.

FIG. 13 shows an optical fibre 130 that comprises a pump fibre 131 that is preferably in optical contact with the second core 12 along its length. The pump fibre 131 and the second core 12 are surrounded by the second cladding 13. The refractive index 132 of the pump fibre 131 is preferably equal to the refractive index 14 of the second core 12. The second cladding 13 is preferably a polymer. The pump fibre 131 is preferably a silica fibre having a larger cross-sectional area than the cross-sectional area of the second core 12. The pump fibre 131 is shown as circular but may alternatively be noncircular. The pump fibre 131 and the second core 12 may be separable from each other by removing the second cladding 13. This enables an end of the pump fibre 131 to be separated from the second core 12 and connected to a pump source.

Optical radiation launched into the pump fibre 131 can propagate along the pump fibre 131 in modes 133 that have an effective index 134 larger than the first refractive index 5 of the first cladding 3. The modes 133 can couple across to the first optical modes 101 of the second core 12 along its length. The first optical modes 101 guided by the second core 12 are able to be coupled to the second optical modes 102 of the optical fibre 130 that overlap the active dopant 9 when the optical fibre 130 is perturbed. The second optical modes 102 have effective indices 135 less than the first refractive index 5.

With reference to each of the optical fibres 10, 40, 50, 60, 70, 80, 90, 100, 110, 120 and 130 shown in FIGS. 1 and 4-13, the first cladding 3 acts as a barrier layer that frustrates the couping of optical power between the first core 2 and the second core 12. The first core 2 may be centrally located as shown, or offset from the central axis of the fibre.

When used in an amplifying optical device such as a laser or an amplifier, the optical fibre 10, 40, 50, 60, 70, 80, 90, 100, 110, 120 and 130 can be compared to a prior art double-clad fibre that does not have the barrier layer provided by the first cladding 3. The absorption length of a double clad fibre used in such devices is approximately equal to the absorption length of the pump radiation when coupled only into the first core 2, multiplied by the sum of the cross-sectional areas of the first core 2 and the second core 12, and divided by the cross-sectional area of the first core 2. By including the first cladding 3, the coupling of the pump radiation from the second core 12 that guides the pump radiation to the first core 2 that guides the signal can be significantly reduced. The length of the optical fibre 10 can then become much longer, typically at least two times longer, preferably at least three times longer, and more preferably at least five times longer than the product of the absorption length and the area of the second core 12 divided by the area of the first core 2.

The perturbation 29 shown with reference to FIG. 2 couples the first optical modes 101 guided by the second core 12 to the second optical modes 102 that overlap the active dopant 9. Pump radiation propagating along the second core 12 as the first optical modes 101 can be electively coupled to the second optical modes 102 with one or more of the perturbations 29, and absorbed by the active dopant 9. The active dopant 9 is able to amplify by stimulated emission one or more of the signal modes 31 that are guided by the first core 2.

The second optical modes 102 have effective refractive indices 135 less than the first refractive index 5 of the first cladding 3. The refractive index 4 of the first core 2 can be higher, equal to, or lower than the refractive index 14 of the second core 12. The refractive index 4 is in general preferably higher than the refractive index 14 of the second core 12, but may also be lower than the refractive index 14, or equal to the refractive index 14.

The diameter or width 6 of the first core 2 of the optical fibres 10, 40, 50, 60, 70, 80, 90, 100, 110, 120 and 130 shown in FIGS. 1 and 4-13 may be greater than 50 μm, preferably greater than 100 μm, and more preferably greater than 250 μm.

The first core 2 and the second core 12 of the optical fibres 10, 40, 50, 60, 70, 80, 90, 100, 110, 120 and 130 shown in FIGS. 1 and 4-13 may be separated by a width 7, shown with reference to FIG. 1, greater than 5 μm, preferably greater than 10 μm and more preferably greater than 15 μm. A width 7 of 10 μm will isolate modes propagating along the second core 12 from other modes that overlap the active dopant 9 more strongly than a width 7 of 5 μm. It is preferred that no more than 5% and more preferably no more than 1% of the optical power propagating along the second core 12 of a 1 m long straight fibre is coupled to other modes that overlap the active dopant 9. Preferably, the first cladding 3 reduces the overlap of optical radiation launched into the second core 12 by at least a factor of 2 and preferably by at least a factor of 10 compared to an equivalent optical fibre that does not have the first cladding 3.

The preferred width 16 of the second core 12 may be the smallest width that allows sufficient pump light to be coupled in to achieve the desired launched power whilst launching light primarily to the first optical modes 101. The width 16 of the second core 12 may be greater than 50 μm, preferably greater than 100 μm and more preferably greater than 150 μm. In other cases, a smaller second core 12 may be desirable.

The refractive index 14 of the second core 12 may be greater than 0.001, preferably greater than 0.004, and more preferably greater than 0.01 than the first refractive index 5 of the first cladding 3.

The refractive index 4 of the first core 2 may be greater than the refractive index 14 of the second core 12. The refractive index 4 of the first core 2 may be greater than 0.015 than the first refractive index 5 of the first cladding 3.

The active dopant 9 may be uniformly distributed across the first core 2. Alternatively, the active dopant 9 may be concentrated more around the centre of the first core 2 than at its edges in order to improve the beam quality of stimulated laser radiation emitted from the first core 2 compared to the beam quality of stimulated laser radiation emitted from an optical fibre in which the active dopant 9 is uniformly distributed across the first core 2.

The second core 12 and/or the second cladding 13 may be circular or non-circular.

The optical fibres 80, 90, 110, 120 and 130 may comprise the third cladding 18 shown with reference to FIG. 1. The third cladding 18 can be circular or non-circular.

The optical fibres 10, 40, 50, 60, 70, 80, 90, 100, 110, 120 and 130 shown in FIGS. 1 and 4-13 are depicted as having circular first cores 2 and circular first claddings 3. The first cores 2 and/or the first claddings 3 can be non-circular.

The optical fibres 10, 40, 50, 60, 70, 80, 90, 100, 110, 120 and 130 may comprise silica, silicate glass, phosphate glass, or may be a soft glass such as a member of the fluoride or chalcogenide families of glasses.

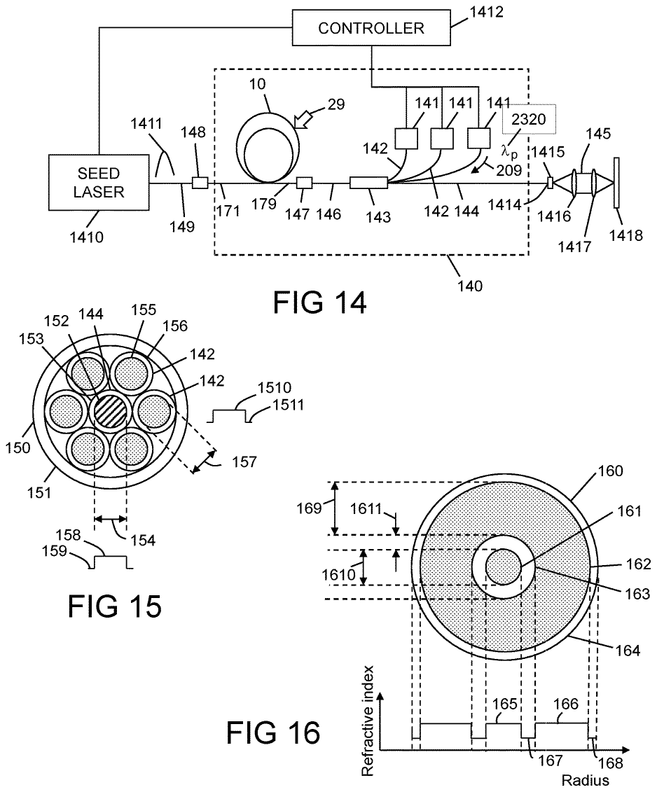

FIG. 14 shows an optical amplifier 140 comprising the optical fibre 10 and at least one pump 141 for providing pump radiation 209 having at least one pump wavelength 2320. The pumps 141 are coupled to the second core 12 of the optical fibre 10 via pump fibres 142 and an output combiner 143. The output combiner 143 also couples the first core 2 to an output fibre 144 which outputs the output signal 145. An optional combiner fibre 146 connects the optical fibre 10 to the combiner 143 via a splice 147. The output fibre 144 may be terminated by an end cap 1415 to protect the output end 1414 of the output fibre 144 being damaged by the output signal 145. End caps 1415 can comprise fused silica. The output signal 145 may be collimated by a collimating lens 1416 and focused by a focusing lens 1417 onto a material 1418 to be processed.

The amplifier 140 can be used to amplify an input signal 1411 emitted from a seed laser 1410 which is input into the input end 171 of the optical fibre 10, amplified by the optical fibre 10, and output from the output end 179 of the optical fibre 10. The input signal 1411 can be coupled into the first core 2 of the optical fibre 10 via an input fibre 149 and a splice 148. The seed laser 1410 can be a fibre laser, a disk laser, a solid-state laser, a slab laser or a semiconductor laser. The seed laser 1410 can be a continuous wave laser, a Q-switched laser, a master oscillator power amplifier laser, or a mode locked laser. A controller 1412 may be provided for controlling the pumps 141, preferably in synchronism with the seed laser 1410. The pumps 141 may be turned on before the seed laser 1410 emits the input signal 1411 in order that the active dopant 9 is energized before the input signal 1411 arrives at the optical fibre 10.

The output combiner 143 may comprise the fibre bundle 150 shown in FIG. 15. Six pump fibres 142 and a central output fibre 144 are bundled together within a capillary 151. The capillary 151 may be silica, may comprise silica, or may be fluorine doped silica. The capillary 151 may be another form of glass such as a soft glass. The capillary 151 may have a single bore as shown or may have multiple bores. The fibre bundle 150 may be coupled to the combiner fibre 146 or directly to the optical fibre 10. The coupling preferably uses a fusion splice, but may also be provided by coupling means such as a butt splice or imaging optics. The capillary 151 may be collapsed by heating and applying tension in order to grip the pump fibres 142, and the fibre bundle may be tapered to resize the pump fibres 142 and central output fibre 144 to appropriately match the dimensions of the fibre to which it will be spliced, which may be the combiner fibre 146 or the optical fibre 10.

The output fibre 144 preferably comprises a core 152 surrounded by a cladding 153 wherein the refractive index 158 of the core 152 is higher than the refractive index 159 of the cladding 153. The core 152 may comprise or may be silica, and the cladding 153 may be fluorine doped silica. The inclusion of the cladding 153 enables the core 152 to be isolated from pump radiation 209 propagating along the pump fibres 142 within the output combiner 143.

Alternatively or additionally, the pump fibres 142 may comprise a core 155 surrounded by an optional cladding 156 wherein the refractive index 1510 of the core 155 is higher than the refractive index 1511 of the cladding 156. The core 155 may comprise or may be silica, and the cladding 156 may be fluorine doped silica. The inclusion of the cladding 156 enables the core 152 of the output fibre 144 to be isolated from pump radiation 209 propagating along the pump fibres 142. The cladding 156 may also isolate the core 155 of the pump fibre 142 from the capillary 151, thus helping to preserve the brightness of pump radiation 209 propagating along the pump fibres 142.

The combiner fibre 146 may be the combiner fibre 160 shown in FIG. 16 which comprises a central core 161 surrounded by a ring core 162. The central core 161 is preferably surrounded by an inner cladding 163 with a refractive index 167 less than the refractive index 165 of the central core 161 and the refractive index 166 of the ring core 162. This choice enables pump radiation 209 coupled into the ring core 162 from the pump fibres 142 to be isolated from the central core 161, and thus be coupled to the second core 12 of the optical fibre 10 and not to the first core 2 of the optical fibre 10. The width 1611 of the inner cladding 163 may be the same as or greater than the width 7 of the first cladding 3 shown in FIG. 1. The ring core 162 may be surrounded by an outer cladding 164 having a refractive index 168 less than the refractive index 166 of the ring core 162. The outer cladding 164 may comprise glass or a polymer coating. The central core 161 may comprise or may be silica, and the inner cladding 163 may be fluorine doped silica.

It is preferable that the pump power 209 launched into the pump fibres 142 is coupled mainly to the second core 12 of the optical fibre 10. The greater the proportion of the pump power 209 that is coupled into the second core 12 compared to the total pump power coupled into the optical fibre 10, the less the absorption of the pump power by the active dopant 9 within the first core 2 before the perturbation 29. This is beneficial because the absorbed pump power can generate heat which may need to be removed if it causes the undesirable temperature rises of the optical fibre 10. In order to maximize this proportion:
the diameter 157 of the core 155 of the pump fibre 142 shown in FIG. 15 is preferably equal to or smaller than the width 169 of the ring core 162 shown in FIG. 16;
the width 169 of the ring core 162 is preferably equal to or smaller than the width 16 of the second core 12 shown in FIG. 1;
the centre lines and outer diameters of the respective cores are preferably aligned such that optical radiation does not couple into the cladding areas surrounding the cores; and
the numerical apertures of each core that receives pump radiation 209 is preferably equal to or greater than the numerical aperture of the pump radiation 209 that is being emitted from the preceding core. The numerical aperture of the pump radiation 209 can be controlled by the launch conditions into the fibre. Alternatively or additionally, it can be controlled by selecting the numerical aperture of the fibre's core with respect to its cladding.

It is preferable that signal radiation emitted from the first core 2 of the optical fibre 10 couples as efficiently through the central core 161 of the combiner fibre 160 (if present) and the core 152 of the output fibre 144. In order to maximize this efficiency:
the diameter 6 of the first core 2 shown in FIG. 1 is preferably equal to or smaller than the diameter 1610 of the central core 161 of the combiner fibre 160 (if present) shown in FIG. 16;
the diameter 1610 of the central core 161 of the combiner fibre 160 is preferably equal to or smaller than the diameter 154 of the core 152 of the output fibre 144 shown in FIG. 15;
the centre lines and outer diameters of the respective cores should be aligned such that signal radiation does not couple into the cladding areas surrounding the cores; and
the numerical apertures of each core that receives signal radiation is equal to or greater than the numerical aperture of the signal radiation that is being emitted from the preceding core. The numerical aperture of the signal radiation can be controlled by the launch conditions into the respective fibre. Alternatively or additionally, it can be controlled by selecting the numerical aperture of the respective core with respect to its cladding.

The signal waveguide comprising the first core 2 and the first cladding 3 shown in FIG. 1 may be multimoded. The input fibre 149 may be single moded, or may be a multimode fibre operated in the fundamental mode. The splice 148 may include a taper. A cladding mode stripper (not shown) can be included in the splice 148, the input fibre 149 or within the seed laser 1410. This arrangement can reduce problems associated with reflections from a work piece being amplified by the amplifier 140 and damaging the seed laser 1410 because the input fibre 149 and/or the cladding mode stripper act as a mode filter, reducing the energy of the back reflected radiation that reaches the seed laser 1410. It should be noted that tapers can increase the divergence of rays that propagate along the core. Care should therefore be taken to avoid tapering that causes optical radiation to couple out of the core by amounts that in operation would lead to undesirable thermal loads on the optical fibre 10.

The optical amplifier 140 shown in FIG. 14 is counter-pumped, that is the pump radiation 209 is launched into the output end 179, that is the end of the optical fibre 10 that emits the output signal 145. Counter pumping generally has the advantage of increasing output power and pulse energy. The optical amplifier 140 can alternatively be co-pumped, that is the pump radiation 209 is launched into the input end 171 of the optical fibre 10, or both counter-pumped and co-pumped. More than 1 kW, preferably more than 2 kW, and more preferably more than 3 kW of pump radiation 209 may be guided by the second core 12.

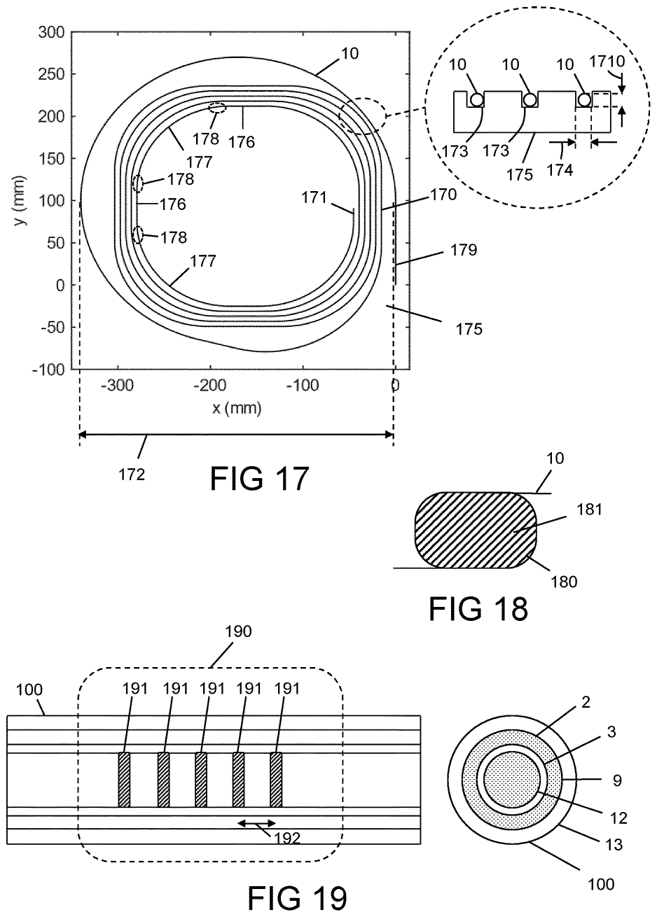

The optical fibre 10 shown in FIG. 14 can be configured in a spool 170 as shown in FIG. 17. The optical fibre 10 is inserted into a spiral groove 173 of a base plate 175. The groove 173 may comprise sections having constant or variable radii of curvature. The length of the bend transitions of the optical fibre 10 may be controlled by making the width 174 of the groove 173 larger than the width or diameter 1710 of the fibre 10.

The base plate 175 can be a heat sink which may be air cooled using fans, or water-cooled using channels within the base plate 175. The groove 173 has a width 174 which can be designed to force the optical fibre 10 to follow the desired trajectory that optimises the mode coupling. The larger the difference in the width 174 of the groove 173 and the width 1710 of the fibre 10, the less constrained the optical fibre 10 will be to follow the curvature of the groove 173. When placed in the groove 173, the fibre 10 will relax to the shape under which it experiences least stress. This leads to a fibre in a wider groove changing its radius of curvature over a greater distance when encountering a change in radius of curvature of the groove, that is, it leads to a longer effective transition length or a perturbation 29 having lower spatial frequencies. The width 174 may be between 25 μm and 150 μm larger than the width 1710. Other widths 174 may also be used.

Optimum radii of curvature and transition regions can be found experimentally by varying the perturbation 29 of the optical fibre 10, the difference in the width 1710 of the optical fibre 10 and the width 174 of the groove 173, and measuring the amounts of cross-coupling between different groups of modes. Alternatively, it may be optimized theoretically as explained with reference to Example 1.

The spool 170 can be in the form of a rounded regular or irregular shaped polygon having edges 176 that have a larger radius of curvature than a radius of curvature at the corners 177. The edges 176 may be straight edges. Examples are rounded polygons with between three and twelve edges and corners that are curved. The rounded polygon may be a rounded rectangle, a rounded square, a super-ellipse or a squircle. For manufacturing simplicity, the spool 170 shown in FIG. 17 is in the form of a rounded square having straight edges 176 and rounded corners 177. The rounded corners 177 have the same length and radius as each other, and are offset from each other to form the spiral. Pump radiation can be coupled from the second core 12 at the transition 178 between each edge 176 and each corner 177 of the fibre 10 into modes or rays that are absorbed by the active dopant 9. By having multiple transitions 178, the pump radiation 209 can be coupled in a controlled manner along the length of the optical fibre 10.

Mode coupling of the first optical modes 101 to the B modes 37 of FIG. 3 is induced by transitions 178 between lengths of the optical fibre 10 that have different radii of curvature. The sharper the transition, the higher the spatial frequency content of the perturbations 29. The sharpness of the transition is related to the rate of change of curvature of the optical fibre 10 along the length of the transition, which rate of change is limited by the glass diameter 8 of the optical fibre 10, and hence the stiffness of the optical fibre. The glass diameter 8 in FIG. 1 is shown as the diameter of the second cladding 13. If the third cladding 18 were glass and not a polymer, then the glass diameter 8 would be the diameter or width of the third cladding 18. Similarly, if the second cladding 13 were a polymer, then the glass diameter 8 would be the diameter or width 17 of the second core 12.

Referring to FIG. 17, the radius of curvature of the optical fibre 10 at the corners 177 and the transitions 178 are preferably selected to couple the first optical modes 101 to the B modes 37 of FIG. 3 without coupling the signal modes 31 to the B modes 37. This can be achieved because the effective mode spacings 33 of the signal modes 31 of the optical fibre 10 shown in FIGS. 1 and 3 is larger than the effective mode spacings 36 of the first optical modes 101. The signal modes 31 are coupled together by perturbations having a higher spatial frequency (sharper transition region) than perturbations that would couple the first optical modes 101 together. Thus if these higher spatial frequencies are avoided, then the first optical modes 101 can be made to couple together and couple to the B modes 37 while at the same time, minimizing the coupling of the signal modes 31 to other signal modes 31 and to the B modes 37. Power in the first optical modes 101 can therefore be scattered out of the second core 12 at each transition 178 into modes that overlap the active dopant 9.

The radius of curvature of the optical fibre 10 at the corners 177 and the transitions 178 may also be selected such that they do not cause coupling between the signal modes 31 as this may degrade the optical beam quality of the output signal 145 described with reference to FIG. 14. This may be advantageous for certain cutting and microwelding applications. Alternatively, the radius of curvature of the optical fibre 10 at the corners 177 and the transitions 178 may be selected such that they cause coupling between the signal modes 37 in order to generate an output signal 145 that is multimoded, and which has a relatively poor beam quality. This may be advantageous for certain welding or cleaning applications. It is preferred that the mode coupling between the signal modes 31 is smaller than the mode coupling between the first optical modes 101.

The optical amplification process (absorption and stimulated emission) causes heat to be generated. The output end 179 of the spool 170 (that is the end of the optical fibre 10 that emits the output signal 145) preferably has no sudden transitions between lengths of fibres having different bend radii, and therefore has reduced mode coupling compared to the rounded corners 177 and the transitions 178. The optical fibre 10 may be characterized by a temperature rise above a temperature of the baseplate 175 which preferably acts as a heat sink. The strength and disposition of the perturbations 29 are preferably such that when the optical fibre 10 is pumped by the pump 141, the temperature rise is less than 100° C., preferably less than 70° C., and more preferably less than 50° C.

The radius of curvature and/or the transitions 178 may be the same at each corner 177 of the spool 170. Alternatively, at least one corner of the spool 170 may have a different radius of curvature than the other corners. The latter may be advantageous for coupling different groups of modes together.

The radius of curvature of the optical fibre 10 may be larger at the output end 179, the end of the optical fibre that is connected to the output fibre 144, than at the input end 171, the end of the optical fibre 10 that is connected to the seed laser 1410. This can be advantageous to reduce coupling between the first optical modes 101 and the second optical modes 102, and the subsequent absorption by the active dopant 9, where the signal power is higher. Alternatively or additionally, it may increase coupling where the signal power is lower.

The spool 170 is shown with the optical fibre 10 being constrained by the spiral groove 173. Alternatively or additionally, the optical fibre 10 may be constrained by adhesives and/or bosses, pins or pegs in order to achieve the desired bend transitions.

FIG. 18 shows a spool 180 in which the optical fibre 10 is wound onto a spool former 181 that has straight edges and rounded corners. The shape of the spool 181 is preferably a polygon with rounded corners. The shape of the spool 180 may be of a similar design to the various spool shapes described with reference to FIG. 17.

The optical fibre 10 used in the spool 170 or the spool 180 may have a glass diameter 8 less than 1 mm, preferably less than 0.9 mm, and more preferably less than 0.8 mm.

The optical fibre spool 170 or 180 may characterized by a minimum bend radius at the corners 177 and the transitions 178 less than 20 mm, preferably less than 15 mm, and more preferably less than 10 mm.

The optical fibre spool 170 or 180 may be characterized by a cross-sectional width 172 less than 500 mm, preferably less than 400 mm, and more preferably less than 300 mm. Optical fibre spools made from optical fibres that do not have the first cladding 3 and that have equivalent optical characteristics to the optical fibre spool 170 typically require optical fibres having larger glass diameters 8.

The optical fibre 10 in the spool 170 or the spool 180 may be the optical fibre 40, 50, 60, 70, 80, 90, 100, 110, 120 or 130 shown in FIGS. 4-13 respectively.

FIG. 19 shows the perturbations 29 in the form of a long period grating 190 written into the second core 12 of the optical fibre 100 described with reference to FIG. 10. The long period grating 190 has regions 191 whose refractive index has been modified by exposure to ultraviolet radiation. The regions 191 have a spatial frequency equal to 1/pitch 192 selected to couple modes guided by the second core 12 to other modes of the optical fibre 100 that overlap the active dopant 9 in the first core 2. The modes guided by the second core 12 are coupled or scattered together by the long period grating 190, and coupled or scattered to the other modes of the optical fibre 100. The pitch 192 is preferably equal to the pump wavelength λ divided by the effective index mode spacing 36. This arrangement is useful in optical fibres such as the optical fibre 100 that have effective index mode spacings 33 between the signal modes 31 guided by the first core 2 smaller than the effective index mode spacings 36 of the first optical modes 101 guided by the second core 12. This is because it is more difficult to couple the first optical modes 101 together without coupling the signal modes 31 together using bends and bend transitions such as shown in FIG. 17 in such fibres.

Long period gratings can also be used to couple the first optical modes 101 guided by the second core 12 to the second optical modes 102 that overlap the active dopant 9 in the optical fibres 10, 40, 50, 60, 70 80, 90, 110, 120 and 130.

Other forms of long period gratings can also be used, including those based on applying periodic bending or pressure onto the optical fibre 100.

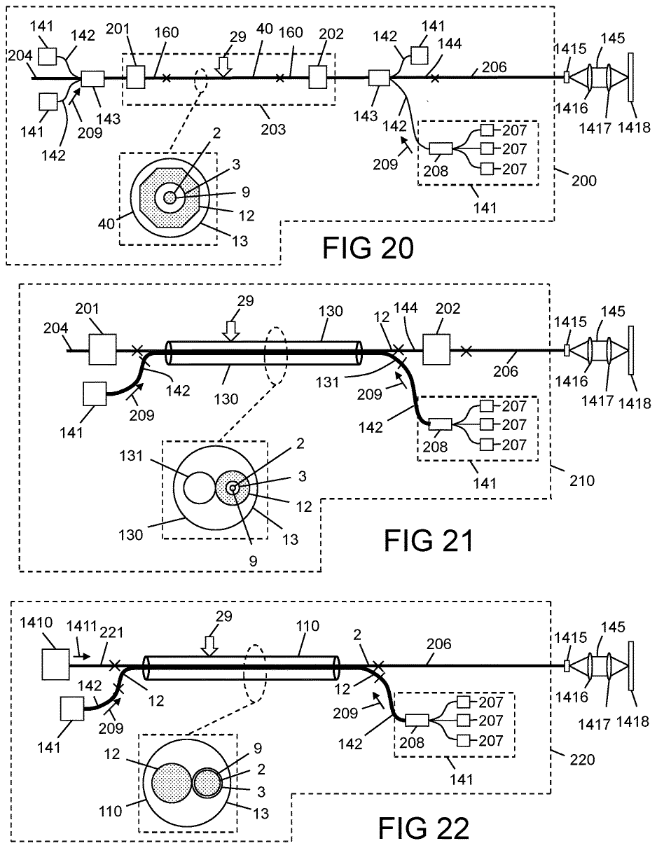

FIG. 20 shows an end-pumped fibre laser 200 comprising the optical fibre 40, optional combiner fibres 160 between the optical fibre 40 and the respective output combiners 143, an optional input fibre 204, and an optional output fibre 144. Reflectors 201, 202 are located at either end of the optical fibre 40 to form a laser cavity 203. The reflectors 201 and 202 are preferably optical fibre Bragg gratings which may be written into the combiner fibres 160. Alternatively, the optical fibre Bragg gratings may be written into the optical fibre 40, or the input fibre 204 and the output fibre 144.

Pump sources 141 are coupled into the second core 12 of the optical fibre 40 via the pump fibre 142, the output combiners 143 described with reference to FIGS. 14-16, and the optional combiner fibres 160. The optional combiner fibres 160, described with reference to FIG. 16, preferably have a ring core 162 that has the same shape and size as the second core 12 of the optical fibre 40. Alternatively, the ring core 162 may be circular and smaller than the second core 12 in order to ease splicing requirements.

The pump sources 141 can comprise laser diodes, laser diode modules comprising a plurality of laser diodes, or laser diode bars. The pump sources 141 can comprise one or more fibre lasers. The pump sources 141 can comprise a plurality of pump sources 207 whose outputs are combined together with a pump combiner 208. The pump sources 207 can be individual laser diodes, laser diode modules each comprising a plurality of laser diodes, laser diode bars, or fibre lasers. The pump combiner 208 can be a fused fibre pump combiner. The pump sources 207 may emit pump radiation 209 having the same pump wavelength 2320. Alternatively, different ones of the pump sources 207 may emit pump radiation 209 having different pump wavelengths 2320. Having the ability to select different pump wavelengths 2320 can be advantageous if the pump absorption by the active dopant 9 is different at these wavelengths.

The optical fibre 40 is perturbed by one or more of the perturbations 29 in order to couple the pump radiation 209 emitted by the pumps 141 from the second core 12 to the active dopant 9. The optical fibre 40 can be configured in the same or similar way as the optical fibre 10 as described with reference to FIGS. 17 to 19. The optical fibre 40 can be replaced with the optical fibre 10, 50, 60, 70, 80, 90 or 100 described with reference to FIGS. 1 and 5 to 10 respectively.

The fibre laser 200 may be connected to an optional beam delivery fibre 206 which may be terminated by the end cap 1415. The collimating lens 1416 and the focusing lens 1417 may also be provided to focus the output signal 145 onto the material 1418 to be processed.

FIG. 21 shows a side-pumped laser 210 comprising the optical fibre 130 described with reference to FIG. 13. The second cladding 13 has been removed from each end of the optical fibre 130, and the pump fibre 131 and the second core 12 separated from each other. The pump radiation 209 from at least one pump source 141 is coupled into the pump fibre 131 via the optical fibre 142. The pump radiation 209 couples to the second core 12, and is then coupled by the perturbation 29 to the active dopant 9 in the first core 2. The reflectors 201 and 202 may be dichroic mirrors or gratings configured to promote light generation within the optical fibre 130 by reflecting optical energy back into the first core 2. The reflectors 201 and 202 are preferably optical fibre Bragg gratings. The resulting output signal 145 is output via the optional beam delivery fibre 206. Alternatively, or additionally, the laser 210 can also be end pumped, for example, by providing the output combiner 143 described with reference to FIG. 14, and coupling pump radiation 209 into the second core 12.

FIG. 22 shows a side pumped laser 220 which is in the form of a master oscillator power amplifier similar to the laser described with reference to FIG. 14. The side pumped laser 220 comprises the optical fibre 110 described with reference to FIG. 11. The second core 12 is connected to at least one pump 141. The first core 2 is connected to the seed laser 1410 via the optical fibre 221. The input signal 1411 emitted by the seed laser 1410 is amplified by the active dopant 9 within the first core 2, and the resulting output signal 145 is output via the beam delivery fibre 206. The optical fibre 110 can be replaced by the optical fibre 110 or 130 of FIGS. 11 and 13 respectively. If the optical fibre 130 were used instead of the optical fibre 110, then the second core 12 of the optical fibre 130 could be both end pumped, as described with reference to FIG. 14, and side pumped.

The fibre lasers 200, 210 and 220 are shown as being both counter-pumped and co-pumped. Higher pulse energies may be attainable if the fibre lasers 200, 210, and 220 were only counter-pumped. Only one amplification stage is shown. However, the lasers can comprise multiple amplification stages.

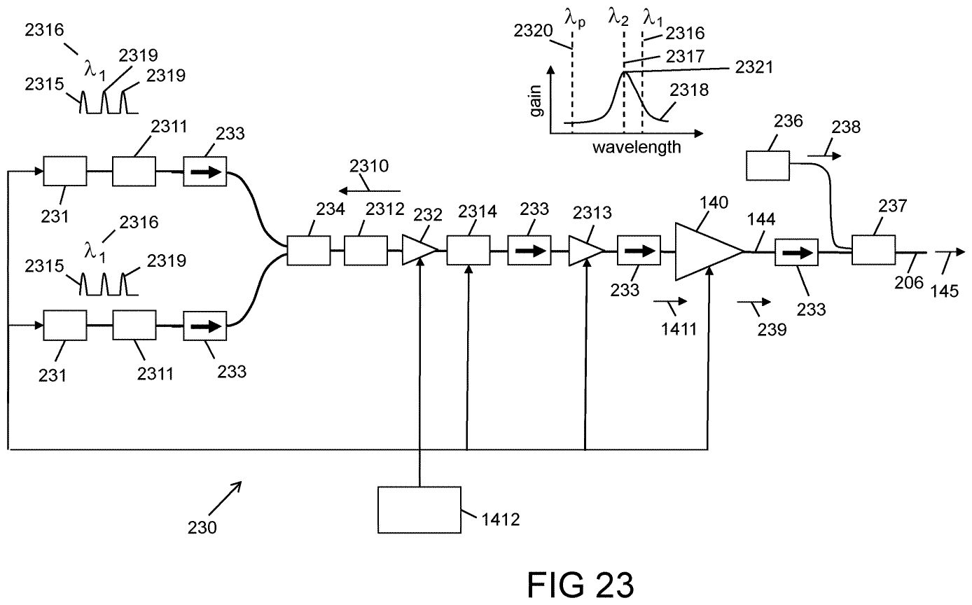

FIG. 23 shows the amplifier 140 of FIG. 14 incorporated as the power amplifier in a master oscillator power amplifier (MOPA) 230. The MOPA 230 comprises at least one seed source 231 for providing seeding radiation 2315 and a first preamplifier 232 for amplifying the seeding radiation 2315. A second preamplifier 2313 may also be provided.

Optical isolators 233 may be disposed between the seed source 231 and the first preamplifier 232, the first preamplifier 232 and the second preamplifier 2313, the second preamplifier 2313 and the amplifier 140. The optical isolators 233 protect the seed source 231 and the first and second preamplifiers 232, 2313 from backward travelling radiation 2310 emitted by the amplifier 140.

An optical isolator 233 may also be disposed at the output of the amplifier 140 to attenuate optical radiation reflected or emitted from a work piece.

The seed source 231 may comprise a Fabry Perot semiconductor laser.

The seed source 231 may comprise a superluminescent diode.

The seed source 231 may be able to emit signal pulses 2319 having pulse widths between 100 ps and 10 ms, and the amplifying optical device may be configured to emit individual pulse energies greater than 50 mJ, preferably greater than 100 mJ, and more preferably greater than 200 mJ. It is believed pulse energies for pulses having pulse widths between 100 ps and 1000 ns up to and exceeding 1 J may be attainable.

A reflector 2311 may be configured to reflect a proportion of the seeding radiation 2315 into the seed source 231. This can help prevent the formation of random pulses being generated in the MOPA 230 which can cause catastrophic damage to the MOPA. The reflector 2311 may be a fibre optic Bragg grating.

The seeding radiation 2315 may comprise optical pulses 2319 characterized by a signal wavelength 2316. The amplifier 140 may have an optical gain 2318 that varies with wavelength, and which has a gain peak 2321 at a gain peak wavelength 2317. The seed source 231 may be selected such that the signal wavelength 2316 is within 10 nm, preferably within 2 nm, and more preferably within 1 nm of the gain peak wavelength 2317.

The MOPA 230 may comprise a depolarizer 2312 between the seed source 231 and the first preamplifier 232. The depolarizer 2312 may be a Lyot depolarizer. The Lyot depolarizer may comprise two lengths of polarization maintaining optical fibre spliced together, with one length being twice the length of the other. When using a single seed source 231, it is found that a depolarizer scrambles the polarization of the seeding radiation prior to it entering into the first preamplifier 232, and thus enables the peak power of the output signal 145 to be increased before non-linear effects such as stimulated Brillouin scattering become problematic. When using two or more seed sources 231, the polarization may be scrambled by aligning the input polarization of the signals from the two seed sources 231 at an angle to each other as they enter the coupler 234. The angle may be 45 degrees or 90 degrees.

The MOPA 230 may comprise at least two seed sources 231. The outputs from the seed sources 231 may be combined by a coupler 234. The seed sources 231 may have the same signal wavelength 2316. The coupler 234 may be a polarization beam combiner. The seed sources 231 may have different signal wavelengths 2316. The coupler 234 may be a wavelength division multiplexer. The coupler 234 is preferably a fused fibre coupler. Alternatively or additionally, the optical fibre 10 may have a plurality of the first cores 2, and the outputs from each of the seed sources 231 may be coupled to different ones of the first cores 2. Such optical fibres were described with reference to FIGS. 8 and 9. Arrangements with more than one first core 2 may be advantageous for certain welding applications in which more than one laser spot is imaged onto the workpiece.

The MOPA 230 may comprise an optical switch 2314. The optical switch 2314 may be an acousto-optic modulator. The optical switch 2314 may be used to reduce amplified spontaneous emission ASE emitted from the first preamplifier 232 between pulses 2319, and thus reduce the ASE being amplified by the amplifier 140. The optical switch 2314 may also be used to reshape the pulses 2319 if the seed source 231 does not output the desired pulse shape. This may be advantageous if a pulse with a slow ramp is desired which can be difficult to produce from a semiconductor laser diode.

The optical switch 2314 may also be placed after the second preamplifier 2313 or after the amplifier 140. However, the power rating of the optical switch 2314 may need to be higher which adds cost.

The MOPA 230 may comprise a visible laser diode 236 and a coupler 237, wherein the coupler 237 is configured to combine visible optical radiation 238 emitted from the visible laser diode 236 and optical radiation 239 emitted from the optical amplifier 140. The coupler 237 is preferably a wavelength division multiplexer. The wavelength division multiplexer may be a fused fibre coupler or a dichroic mirror.

The apparatus may comprise a controller 1412 for controlling the seed source 231, the first preamplifier 232, the second preamplifier 2313 (if fitted), the optical switch 2314 (if fitted) and the amplifier 140. When amplifying the optical pulses 2319, it is preferred that the first and the second preamplifiers 232, 2313 are turned on (that is energized by the pumps) before the amplifier 140 is turned on, in order to prevent damage to the amplifier 140. The amplifier 140 may be turned on, for example by the controller 1412, before the first of the pulses 2319 arrives in order to ensure that the first pulse is amplified the same as the subsequent pulses.

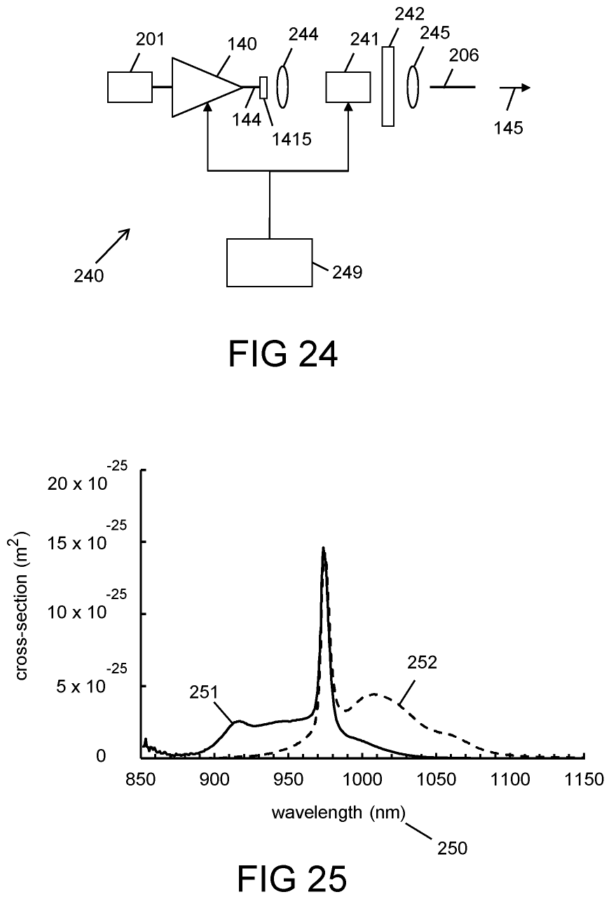

FIG. 24 shows the amplifier 140 of FIG. 14 incorporated as the power amplifier in a Q-switched laser 240. The Q-switched laser 240 comprises the reflector 201 of FIGS. 20 and 21, the amplifier 140, a Q-switch 241, and an output coupler 242. The Q-switch 241 may be a free-space optical Q-switch. Optical radiation emitted from the amplifier 140 may be coupled to the output coupler 242 via a collimating lens 244 and the Q-switch 241. An end cap 1415 is preferably provided at the end of the output fibre 144 to prevent optical radiation damaging the end face of the output fibre 144. A controller 249 synchronizes the pumping of the optical fibre 10 and the opening of the Q-switch 241 to promote light generation within the optical fibre 10. The resulting output signal 145 may be focused by the output lens 245 and output via the beam delivery fibre 206. The beam delivery fibre 206 may be a solid glass fibre, or a fibre having a microstructured or hollow core. The Q-switch 241 can be an acousto-optic modulator, an electro-optic switch, or a mechanical Q switch for example comprising a rotating mirror or prism. It should be noted that the amplifier 140 can be replaced by other amplifying optical arrangements including the amplifiers shown in FIGS. 20-23, and may use one of the optical fibres 10, 40, 50, 60, 70, 80, 90, 100, 110, 120 and 130 shown in FIGS. 1 and 4-13.

In the following examples, the MOPA 230 shown in FIG. 23 was modelled for several types of optical fibre 10. The MOPA 230 comprised one seed source 231 and the amplifier 140 of FIG. 14. The optical fibre 10 used in Examples 1 and 3-6 was the optical fibre 310 of FIG. 31, which is similar to the optical fibre 40 of FIG. 4 but without the third cladding 18. The second cladding 13 was a polymer.

The optical fibre used in Example 2 was the equivalent optical fibre 320 which is equivalent to the optical fibre 310 but without the first cladding 3. The design of the first cores 2 are identical with the same refractive index 4, the same core diameter 6, and the same concentration of the active dopant 9. The design of the second core 12 of the equivalent optical fibre 320 extends to and is in optical contact with the outside circumference of the first core 2. The refractive index 14 of the second cores 12 are the same in the optical fibre 310 and the equivalent optical fibre 320. As will be explained below, when used in an amplifying optical device such as an amplifier or a laser, the inventive optical fibre 310 can have a fibre length that is at least twice the length of the equivalent optical fibre while absorbing the same amount of pump radiation along its length. By selecting the strength and disposition of the perturbations 29 along the optical fibre 310, the pulse energy can be higher, the gain peak wavelength 2317 can be at a longer wavelength, and the gain peak 2321 can have a higher gain at the signal wavelength 2316 when the amplifying optical device uses the optical fibre 310 than when the amplifying optical device uses the equivalent optical fibre 320.

Bending of an optical fibre confined in the groove 173 of FIG. 17 was modelled using Cosserat rod theory, which is a method of modelling slender rods in bending and other deformations. This was used to create a plot of radius of curvature versus distance along the fibre 10.

The pump absorption was modelled using a Beam Propagation Method (BPM), which simulates the propagation of an optical field in a defined refractive index structure. The radius of curvature as determined by the Cosserat model was represented by applying a gradient in the value of the refractive index along one of the cross-sectional directions of the fibre model. The absorbing properties of the active dopant 9 on the pump radiation 209 were represented by an imaginary refractive index component, calculated from the chosen dopant concentration and absorption cross-section of chosen dopant.

A rate equation model was used to determine the signal gain and amplified spontaneous emission characteristics of the fibre 10, with the pump absorption calibrated with the results of the BPM absorption model. As well as the amplified spontaneous emission generated in the power amplifier 140, the model considered amplified spontaneous emission generated in the first and second preamplifiers 232, 2313 of FIG. 23, which can be input into and amplified by the amplifier 140. The amount of amplified spontaneous emission input depends on the characteristics of the preamplifiers 232, 2313 and any (deliberate or accidental) wavelength filtering effects in the isolators 233, and so will vary depending on the details of the laser system.

The thermal load on the fibre 10 was calculated. The thermal load is caused by pump absorption and the quantum defect. The quantum defect arises because of the difference between the energy of pump and signal photons. The maximum temperature of the fibre 10 was calculated at the location along the fibre with the highest heat load using a two-dimensional thermal model representing the cross-section of the fibre and the base plate 175. It was assumed the space between the fibre 10 and the base plate 175 was filled with polyacrylate. Typical thermal properties of silica for the fibre, polyacrylate for the fibre coating and the filling, and aluminium for the base plate 175 were used. The values for the maximum temperature rise given in the examples below refer to the point with highest temperature rise in the polyacrylate. Degradation of fibre coatings with heat is a well-known issue when operating fibre lasers at high optical powers and therefore high fibre temperatures.

The BPM was also used to simulate perturbations of the signal in the fibre 10. Gain was applied in the form of an imaginary refractive index component in the actively doped region of the fibre 10 to simulate amplification. It was found that for a particular gain and perturbation, the beam quality of the output signal 239 emitted by the amplifier 140 was only weakly affected by the beam quality of the input signal 1411 inputted into the amplifier 140.

The input signal 1411 was multimode, with a field diameter matching the diameter 6 of the first core 2 of the fibre 10. The beam quality of the input signal 1411 was characterized by a beam parameter product BPP of 5.0. The BPP of the output signal 239 was approximately 5.5 for a spool 170 having a 1 mm groove width 174, compared to a BPP of 6.1 for a 0.9 mm groove width 174 and a BPP of 5.0 for a groove width 174 of 1.3 mm. By comparison, pump absorption varied from 0.5 dB/m in the spool with a 1.3 mm groove width 174 to 1.6 dB/m in the spool with a 0.9 mm groove width 174, demonstrating that it is possible to exert considerable control over pump absorption while maintaining good beam quality of the output signal 239.

The modelling was based on the apparatus shown in FIG. 14 using different fibre designs and configurations for the optical fibre 10. In each case, the input signal 1411 into the amplifier 140 had an average power of 20 W.

Example 1 is a preferred arrangement which uses the optical fibre 310 with the first cladding 3 that isolates the active dopant 9 from the pump radiation 209 which was launched only into the second core 12. The active dopant 9 was ytterbium ions. The optical fibre 310 was perturbed as shown in FIG. 17 using the spiral, rounded-square spool configuration, but with very gentle perturbations at the output end 179 (into which the pump radiation 209 was launched) to minimize coupling of the pump radiation 209 to the active dopant 9 and thus minimize heat loading of the optical fibre 310. The function of the first cladding 3 and the perturbations 29 was demonstrated in Example 2 by having exactly the same configuration (fibre design, perturbations 29, and physical layout) but without the first cladding 3. The absorption was so high that the fibre length had to be reduced. The fibre for Example 3 was the same as Example 2 but with a reduced concentration of the active dopant 9. The fibre for Example 4 was identical to Example 1, but with stronger perturbations 29 at the output end 179. The fibre for Example 5 was also identical to Example 1, but with the pump radiation launched into both the first core 2 and the second core 12 at the output end 179. Finally in Example 6, the arrangement of Example 1 was reproduced but with less variation in bend radii to reduce the coupling of the pump radiation 209 from the second core 12.

### Example 1

Referring to FIG. 23, the optical fibre 10 was the optical fibre 310 of FIG. 31 that had a circular first core 2 having a first core diameter 6 of 170 μm. The active dopant 9 was ytterbium with a dopant ion concentration of 7.775×10²⁵/m³. The first core 2 was co-doped with phosphorus and aluminium in proportions to avoid photodarkening. The second core 12 was an octagonal core with a second core diameter 17 of 660 μm. The first cladding 3 comprised silica doped with fluorine to reduce its refractive index and had a thickness 7 of 10 μm. The second cladding 13 was a polymer coating having a diameter of 850 μm. A third cladding 18 was not provided.

The first cladding 3 had a first refractive index 5 that was 0.017 below the refractive index 4 of the first core 2, and 0.004 below the refractive index 14 of the second core 12.

The second cladding 13 had a second refractive index 15 that was 0.07 below the refractive index 14 of the second core 12.

The optical fibre 10 was formed into a spool 170 by inserting it into the spiral groove 173 of the base plate 175. The groove 173 was in the rounded square configuration shown in FIG. 17 and had a width 174 of 1 mm. The groove 173 had a minimum radius of curvature of 100 mm at the corners 177 of the spool 170, and a maximum radius of curvature of more than 10 m along the edges 176.

The pump wavelength 2320 was 960 nm, and the signal wavelength 2316 was 1065 nm.

The optical amplifier 140 was counter pumped as shown with reference to FIG. 14. The pump radiation 209 was introduced to the optical fibre 310 from the combiner fibre 160 described with reference to FIG. 16, with the pump radiation 209 confined to the ring core 162. There was no pump radiation 209 coupled to the central core 161. This resulted in all of the pump radiation 209 being launched into the second core 12 of the optical fibre 310. The input signal 1411 was introduced into the other end of the optical fibre 310 via a step index fibre with a core size such that all the input signal 1411 was launched into the first core 2 of the optical fibre 310.

By increasing the pump power, it was possible to achieve an output signal 145 comprising pulses having a pulse repetition frequency of 20 kHz, an average output power 2458 W, and a pulse energy of 121 mJ. Pulse energies exceeding 200 mJ would be achievable by increasing the diameter 6 of the first core . . .

The average pump absorption along the optical fibre 310 was 1.0 dB/m, the maximum pump absorption was 1.4 dB/m, and the maximum thermal load at a 2.4 kW average power output was 91 W/m.

The maximum temperature increase above the temperature of the baseplate 175 was 45 C.

The gain peak wavelength 2317 corresponding to the peak in the gain 2318 of the amplifier 140 was 1060 nm. The wavelength at which the amplified spontaneous emission spectrum peaked was also 1060 nm. There was 41 W of amplified spontaneous emission for an average 2458 W output power, representing a little less than 2% of the total output power.

### Example 2

The fibre design and configuration for Example 2 was the same as Example 1 except that the optical fibre 10 was replaced by the equivalent optical fibre 320 described with reference to FIG. 32 that had no first cladding 3 separating the first core 2 and the second core 12. The first core 2 had the same dimensions and design. The second core 12 had the same octagonal shape as shown in FIG. 4, but with an inner diameter equal to the outer diameter of the first core 2. The second core 12 thus acted as the pump cladding of a prior art double-clad fibre. Example 2 is not according to the present invention and is provided to show the benefits of the first cladding 3 and the perturbations 29.

The absence of the first cladding 3 caused the pump radiation 209 to couple to the active dopant 9 at a higher rate per unit length of fibre. The average pump absorption was 4.2 dB/m, and the maximum pump absorption was 4.6 dB/m. The length of the equivalent fibre 320 was reduced from 15 m to 3.9 m to keep the total pump absorption in the equivalent fibre 320 similar to that achieved in the optical fibre 310 of Example 1.

An output signal 145 comprising pulses having a pulse repetition frequency of 20 kHz, an average output power 2371 W, and a pulse energy of 94 mJ was achieved. The gain peak wavelength 2317 was 1028 nm. There was 460 W of amplified spontaneous emission for an average 2.4 kW output power, corresponding to 19% of the total power. It can be seen that without the first cladding 3, the higher pump absorption leads to loss of pulse energy and a very large amount of ASE which degrades performance and risks parasitic lasing near the gain peak wavelength 2317 which may damage the laser.

The high pump absorption also led to a very high peak heat load of 276 W/m. The maximum temperature increase of the optical fibre 320 above the temperature of the baseplate 175 was 137 C.

### Example 3

The fibre design and configuration for Example 3 was the same as Example 2 except that the active dopant 9 (ytterbium ions) had a lower dopant concentration of 1.944×10²⁵/m³. Example 3 was not according to the invention as the optical fibre 320 had no first cladding 3 separating the first core 2 and the second core 12.

The ytterbium concentration was reduced to reduce the rate of pump absorption. The average pump absorption was 1.1 dB/m and the maximum pump absorption was 1.2 dB/m. These are similar values to Example 1. The maximum thermal load at a 2385 W average power output was 70 W/m, which is also similar to Example 1. The maximum temperature increase above the temperature of the baseplate 175 was 35 C.

It was also possible to achieve an output signal 145 comprising pulses having a pulse repetition frequency of 20 kHz, an average output power 2385 W, and a pulse energy of 91 mJ.

The gain peak wavelength 2317 corresponding to the peak in the gain 2318 of the amplifier 140 was 1028 nm. There was 498 W of amplified spontaneous emission, corresponding to 21% of the total output power. These values are similar to those for Example 2, demonstrating that reducing the concentration of the active dopant 9 can improve thermal performance, but does not shift the gain peak wavelength 2317 to an appropriate wavelength or improve the optical performance. This is because reduced doping concentration, whilst reducing total absorption, will not change the fractional inversion of the active ions, and it is the fractional inversion that determines the emission characteristics. Therefore, the level of ASE does not significantly change compared to Example 2, and as with Example 2, represents a significant deterioration in performance of the laser. The associated high gain also provides a risk of damage to the laser.

### Example 4

The fibre design and configuration for Example 4 was the same as Example 1 except that the gentle bends of the optical fibre 310 at the output end 179 (pump launch end) used in Example 1 were omitted. The grooves 173 had curved sections with a radius of curvature of 100 mm, and there were no sections having larger radii of curvature at the output end 179.

This change produced essentially negligible effect on the optical characteristics compared to Example 1, but produced an increase in peak absorption at the output end 179 and hence a modest increase in peak heat load and in maximum fibre temperature.

### Example 5

The fibre design and configuration for Example 5 was the same as Example 1 except that the pump radiation was introduced to the optical fibre 310 from a combiner fibre with a simple step index profile. Pump radiation 209 overlapped with the core of the combiner fibre, and the pump radiation 209 was coupled into both the first core 2 and the second core 12 of the optical fibre 310 in approximate proportion to their cross-sectional areas.

This change produced only a small effect on the optical characteristics compared to Example 1. The gain peak wavelength 2317 corresponding to the peak in the gain 2318 of the amplifier 140 was 1060 nm. There was 13 W of amplified spontaneous emission for an average 2.4 kW output power. These values are similar to those for Example 1, demonstrating that the very short section with high absorption owing to pump radiation 209 being launched directly into the first core 2 does not significantly affect the spectral performance of the amplifier.

However, it had a substantial effect on the thermal characteristics due to the very high gain in a short section of the fibre near the pump launch. The maximum absorption was 6.1 dB/m, with corresponding maximum heat load of 495 W/m and a maximum temperature rise above the base plate 175 of 245 C. Such a high temperature rise is undesirable and would lead to reliability issues.

### Example 6

The fibre design and configuration for Example 6 was the same as Example 1 except that the optical fibre 310 was assembled in a spiral groove with no abrupt changes in bend radius. There was only a very slow, continuous reduction in bend radius over the entire 15 m length of the spool. The consequence of this was that, whilst the maximum absorption, occurring near the signal output end 179 (the pump input end) of the fiber 10, was similar to that for Examples 1, 3 and 4, as a result of the lack of perturbations 29 provided by the lack of variations in bend radius, the absorption fell away quickly in the remainder of the fiber 310. The result was an average value for pump absorption much lower than desired, leading to poor efficiency and low power output due to a substantial fraction of the pump radiation 209 not being coupled from the first optical modes 101 guided by the second core 12 into the second optical modes 102 that overlap and are absorbed by the active dopant 9.

TABLE 1
Examples 1-6: Design Parameters

| | Example | | | | | |
|---|---|---|---|---|---|---|
| Parameters | 1 | 2 | 3 | 4 | 5 | 6 |
| First core | 170 | 170 | 170 | 170 | 170 | 170 |
| diameter (μm) | | | | | | |
| Yb doping | 7.775 | 7.775 | 1.944 | 7.775 | 7.775 | 7.775 |
| concentration | | | | | | |
| (10²⁵/m³) | | | | | | |
| First cladding | 10 | none | none | 10 | 10 | 10 |
| thickness (μm) | | | | | | |
| Refractive | −0.004 | — | — | −0.004 | −0.004 | −0.004 |
| index | | | | | | |
| difference | | | | | | |
| between first | | | | | | |
| cladding and | | | | | | |
| second core | | | | | | |
| Second core | 660 | 660 | 660 | 660 | 660 | 660 |
| diameter (μm) | | | | | | |
| Second core | Octagonal | Octagonal | Octagonal | Octagonal | Octagonal | Octagonal |
| shape | | | | | | |
| Second | 850 | 850 | 850 | 850 | 850 | 850 |
| cladding | | | | | | |
| diameter (μm) | | | | | | |
| Second fibre | None | none | none | none | none | none |
| diameter (μm) | | | | | | |
| Groove | 100 | 100 | 100 | 100 | 100 | 85 |
| minimum | | | | | | |
| radius of | | | | | | |
| curvature(mm) | | | | | | |
| Groove | >10000 | >10000 | >10000 | >10000 | >10000 | 115 |
| maximum | | | | | | |
| radius of | | | | | | |
| curvature(mm) | | | | | | |
| Radius of | 170 | 170 | 170 | 100 | 170 | 115 |
| curvature of 1^{st} | | | | | | |
| curved section | | | | | | |
| of groove | | | | | | |
| (mm) | | | | | | |
| Groove width | 1 | 1 | 1 | 1 | 1 | 1 |
| (mm) | | | | | | |
| Active fibre | 15 | 3.9 | 15 | 15 | 15 | 15 |
| length (m) | | | | | | |
| Pump | 960 | 960 | 960 | 960 | 960 | 960 |
| wavelength | | | | | | |
| (nm) | | | | | | |
| Pump power | 3150 | 3150 | 3150 | 3150 | 3150 | 3150 |
| (W) | | | | | | |
| Pump launch | Annular | annular | annular | annular | circular | annular |
| Signal | 1065 | 1065 | 1065 | 1065 | 1065 | 1065 |
| wavelength | | | | | | |
| (nm) | | | | | | |

TABLE 2
Examples 1-6; Achieved Performance

| Example | 1 | 2 | 3 | 4 | 5 | 6 |
|---|---|---|---|---|---|---|
| Average | 2458 | 2371 | 2385 | 2471 | 2507 | 1450 |
| output power | | | | | | |
| (W) | | | | | | |
| Pulse energy | 121 | 94 | 91 | 122 | 123 | 74 |
| (mJ) | | | | | | |
| Average pump | 1.0 | 4.2 | 1.1 | 1.0 | 1.0 | 0.3 |
| Absorption | | | | | | |
| (dB/m) | | | | | | |
| Maximum | 1.4 | 4.6 | 1.2 | 1.6 | 6.1 | 1.6 |
| pump | | | | | | |
| absorption | | | | | | |
| (dB/m) | | | | | | |
| Max thermal | 91 | 276 | 70 | 99 | 495 | 111 |
| load at 2 kW | | | | | | |
| output (W/m) | | | | | | |
| Max | 45 | 137 | 35 | 49 | 245 | 55 |
| temperature | | | | | | |
| rise above | | | | | | |
| heatsink (C.) | | | | | | |
| Gain peak | 1060 | 1028 | 1028 | 1060 | 1060 | 1060 |
| wavelength | | | | | | |
| (nm) | | | | | | |
| ASE emission | 41 | 460 | 498 | 40 | 42 | 10 |
| at 2 kW output | | | | | | |
| (W) | | | | | | |

FIG. 25 shows the absorption and emission cross-sections 251, 252 as a function of wavelength 250 for ytterbium ions in the ytterbium-doped phosphorus silica glass used in the Examples. The absorption and emission cross-sections Cabs, Cem are measures of the probability that a photon is absorbed or emitted from active dopant 9, which in Examples 1-6 is the ytterbium ion.

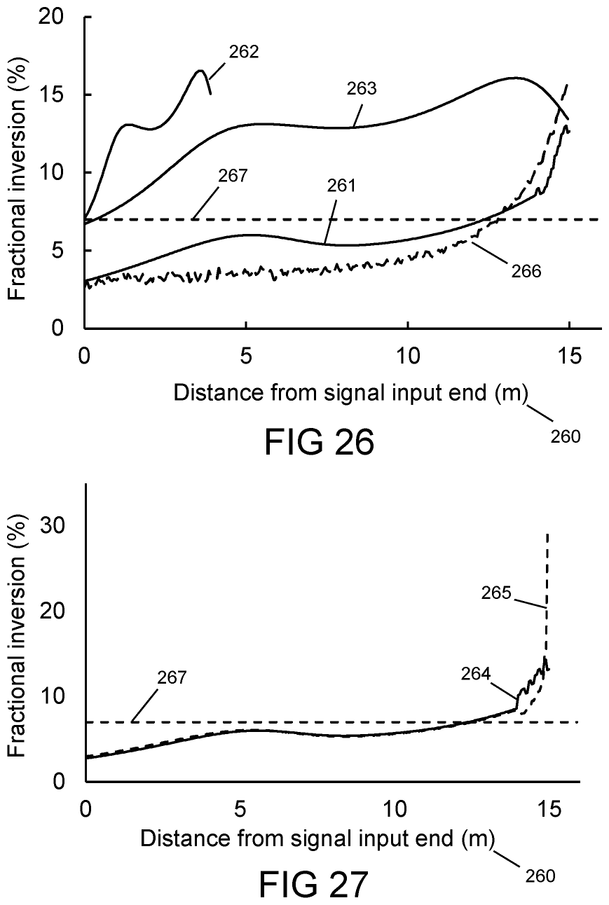

FIGS. 26-30 show the amplified spontaneous emission, fractional inversion, and pump absorption for Examples 1-6. The calculations correspond to the time when a seed pulse from the middle of a pulse chain having a pulse repetition frequency of 20 kHz is about to enter the fibres 310 and 320. The results are representative of the steady state performance of the laser and specifically eliminate transient effects which may occur near the beginning of a pulse chain.

FIG. 26 shows the fractional inversion 261, 262, 263 and 266 calculated for Examples 1, 2, 3 and 6 respectively versus the distance 260 along the optical fibres 310, 320 from the signal input end 171 shown with reference to FIGS. 14 and 17. The fractional inversions 264, 265 for Examples 4 and 5 respectively are shown in FIG. 27. These were similar to the fractional inversion 261 of Example 1, save near the signal output end 179 which is the end at which the pump radiation 209 was launched into the optical fibre 310. The fractional inversion 266 for Example 6 is higher towards the signal output end 179, and falls away to a steady state that is lower than the fractional inversion 261 for the remainder of the fibre 310. The fractional inversions 262 and 263, corresponding to Examples 2 and 3, are significantly higher than the fractional inversion 261 for Example 1.

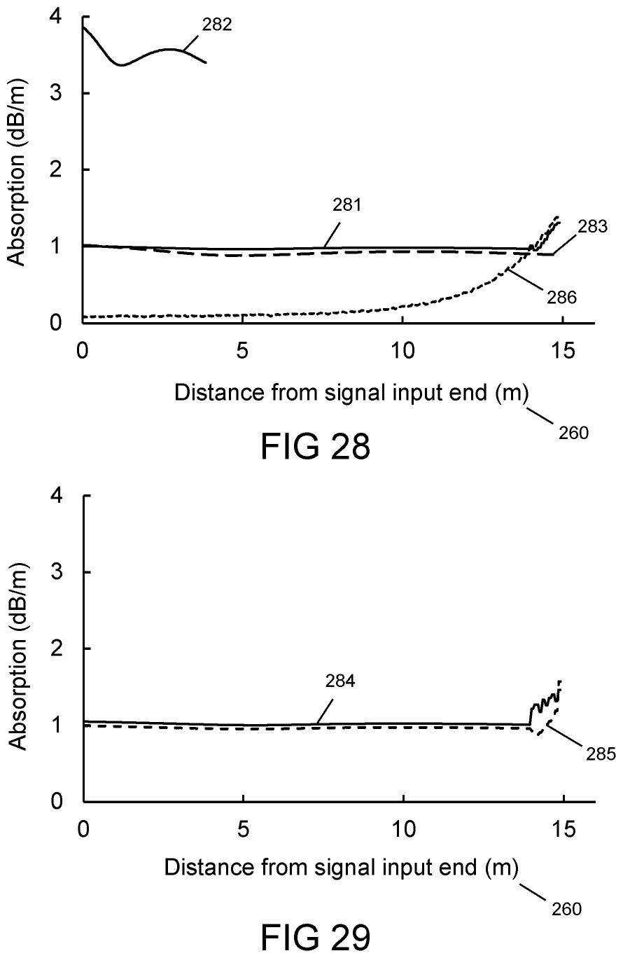

FIG. 28 shows the pump absorption 281, 282, 283 and 286 calculated for Examples 1, 2, 3 and 6 respectively versus the distance 260. The pump absorptions 284 and 285 for Examples 4 and 5 respectively are shown in FIG. 29 and are similar to the pump absorption 281 of Example 1. The pump absorption 282 for Example 2 is significantly higher than the pump absorption 281. The pump absorption 283 was designed to be similar to the pump absorption 281 by reducing the dopant concentration of the active dopant 9. The pump absorption 286 for Example 6 (no perturbations) increases rapidly towards the signal output end 179 because the first cladding 3 isolated the pump radiation 209 propagating along the second core 12 from the active dopant 9.

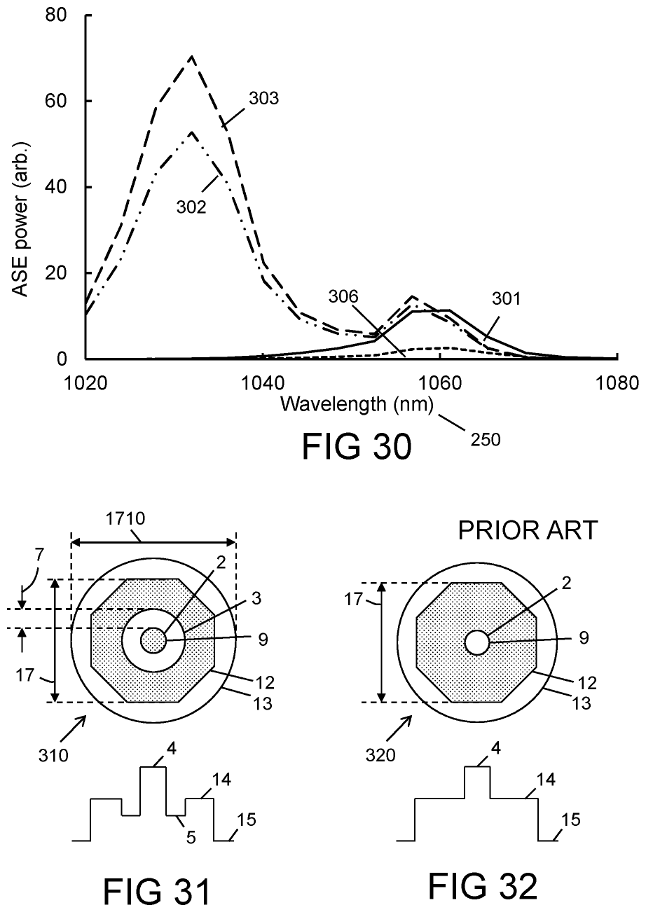

FIG. 30 shows the amplified spontaneous emission (ASE) spectra 301, 302, 303 and 306 emitted by the optical fibres calculated for Examples 1, 2, 3 and 6 respectively versus the wavelength 250. The ASE spectra 304 and 305 for Examples 4 and 5 respectively approximately overlayed the ASE spectrum 301 for Example 1 and are not shown. The ASE spectra 302, 303 for Examples 2 and 3 peak at approximately 1030 nm, whereas the ASE spectra 301, 304, 305 and 306 for Examples 1, 4, 5 and 6 peak at approximately 1060 nm.

Referring to FIGS. 26 and 27, the ASE spectra 301, 304, 305 and 306 of FIG. 30 peak near the desired signal wavelength 2316 of 1065 nm because the fractional inversions 261, 264, 265 and 266 are less than a transitional fractional inversion 267 along at least the first half of the optical fibre 310. For ytterbium dopant, the transitional fractional inversion 267 is less than 10%, preferably less than 8%, and more preferably 7%. This can be compared with the fractional inversions 262 and 263 which exceed the transitional fractional inversion 267 along most of the optical fibre 320 and where the ASE peaks at 1030 nm.

Examples 1-3 demonstrate that the first cladding 3 provides a mechanism to reduce the coupling of the pump radiation 209 from the first optical modes 101 propagating along the second core 2, and the second optical modes 102 that overlap the active dopant 9, without changing the outer dimensions of the second core 12, and without changing the concentration of the active dopant 9. This not only reduces the thermal load on the fibre considerably, but shifts the gain peak wavelength 2317 from approximately 1030 nm to approximately 1060 nm. This favours operation at a signal wavelength 2316 where the emission cross-section 252 is low enough to allow energy storage sufficient for the generation of nanosecond pulses without excess ASE and without the risk of parasitic lasing destroying the laser. For operation at 1065 nm, the fractional inversion of the active dopant 9 along at least 70% of the length of the optical fibre 310 is less than 10%, preferably less than 8%, and is more preferably equal to 7%.

In Example 1, amplified spontaneous emission (ASE) comprised just 2% of total output power, whereas in Examples 2 and 3, which did not utilise the first cladding 3, ASE comprised 12% of total output power. The lack of the first cladding 3 in Examples 2 and 3 degraded the performance of the laser by reducing the pulse energy and reducing the contrast between pulse and inter-pulse power, and left the laser at extreme risk of unstable parasitic lasing at the ASE peak wavelength.

Examples 1 and 4 demonstrate the importance of the spool plate characteristics. Advantageously, the optical fibre 310 in Example 1 was laid out with larger radii of curvature at the signal output end 179 (pump launch end), and this reduced the maximum absorption, maximum heat load and maximum temperature compared to Example 4 where all bend sections of the groove 173 had the same radius of curvature. The effect on pulse energy and ASE power was negligible.

Examples 1 and 5 demonstrate the importance of the initial distribution of the pump radiation 209. If a significant amount of pump radiation is launched into the first core 2, as in Example 5, this radiation is partially trapped in the first core 2 by the same mechanism that partially excludes pump radiation in the second core 12 from entering the first core 2. This resulted in a section at the signal output end 179 where the pump absorption was very high. This high absorption section continued until most of the pump radiation 209 that was trapped in the first core 2 had been absorbed by the active dopant 9. Since the region of high absorption was quite short (of order 20 cm) the overall gain characteristics of the amplifier 140 was not significantly changed, and the effect on pulse energy and ASE power was negligible. However, the higher pump absorption corresponded to a higher local heat load and a higher maximum temperature, both of which are undesirable as they can lead to damage of the optical coatings and catastrophic damage to the optical fibre. Alternative fibre coatings such as metal coatings and/or soldering to a heat sink may used. The fibre coating can also be removed entirely in these hotter sections.

In Example 6, the bend radius of the optical fibre 310 changed only gradually, and thus there were no perturbations of the fiber that would couple the first optical modes 101 from the second core 12 to the second optical modes 102 having higher divergence that overlap the first core 2 and the active dopant 9. Although the initial absorption in Example 6 had an appropriate value, slightly higher than the target value achieved in Example 1, the overall absorption was lower than achieved in Example 1. This is because the absorption fell along the length of the fiber 310 as the pump radiation 209 propagated away from the signal output end 179 as the higher-divergent pump rays were absorbed by the active dopant 9, while the lower-divergent pump rays remained being guided by the second core 12 and thus were not absorbed by the active dopant 9. By the time the pump radiation 209 had reached the signal input end 171, the pump absorption had fallen to <0.1 dB/m. The depletion of the higher divergent pump rays led to a low total absorption (<<10 dB) for any reasonable fiber length, resulting in low efficiency and large quantities of wasted pump radiation which had to be disposed of safely. This should be contrasted with Examples 1, 4 and 5 where the perturbations 29 replenished the more highly-divergent pump radiation that overlapped the first core 2, allowing the absorption to be maintained (or even if desired, enhanced) along the whole length of the fibre 310.

In an experiment, the seed laser 1410 of FIG. 14 was a 20 W TruPulse nano laser manufactured by TRUMPF Laser UK Limited of Southampton, England. The TruPulse nano laser has a single seed source 231 and a first and second preamplifier 232, 2313 as shown with reference to FIG. 23, and is thus equivalent to the seed laser modelled in Example 1. The TruPulse nano laser can emit a variety of pulse shapes having different pulse widths, powers and pulse energies. The maximum pulse energy of the 20 W TruPulse nano laser is approximately 1 mJ. With reference to FIG. 14, the fibre 10 was the fibre 310 of FIG. 31, had the same design as modelled in Example 1, and was configured and mounted on a base plate 175 as described with reference to FIG. 17 and Example 1. The amplifier 140 was able to emit 100 mJ pulses, at a pulse repetition frequency of 20 kW, and with an average output power of 2 kW. The heat generated in the optical fibre 310 was able to be removed by the base plate 175, and the resulting temperature rise of the optical fibre 310 was within acceptable limits required to ensure reliable operation over extended periods of operational time.

Experimentally the measured beam parameter product (BPP) of the output signal 145 was 10 mm·mrad, which is larger than the BPP from Example 1. The BPP varied very weakly with spool format. This suggests that the main source of the increase in the BPP of the output signal 145 was not the deliberately induced bending of the fibre (macro-bending). There are other possible sources of BPP increase, such as micro-bending (random variations in the fibre) and BPP increase caused by other optical components such as the combiner. The results confirm that it is possible to manipulate the absorption of the pump radiation by controllably bending the fibre 10 without degrading the signal BPP significantly.

For a beam delivery cable 206 of reasonable length, to avoid excessive nonlinearity for pulses with high peak powers, its core size is preferably larger than the first core diameter 6 of the optical fibre 10. If this increase in core size is achieved using tapered coupling or magnification using free space optics, rather than by simple splicing, it is possible to retain a BPP which is similar to that in the optical fibre 10. Preferably the taper is an adiabatic taper.

The lasers and amplifiers of FIGS. 14 and 20-24 and Examples 1, 4, 5 and 6 are amplifying optical devices for emitting an output signal 145 at a signal wavelength 2316. By appropriate choice of the first cladding 3 and the strength and distribution of the perturbations 29, it is possible to increase the pulse energy available, reduce the levels of ASE between pulses, and to design the gain peak wavelength 2317 at the optimum wavelength for the choice of the active dopant 9 and the glass material of the optical fibre 10.

For example, the active dopant 9 may comprise ytterbium ions, and the gain peak wavelength 2317 may be 1060 nm. The active dopant 9 may comprise erbium or erbium co-doped with ytterbium, and the gain peak wavelength 2317 may be in the range 1555 nm to 1650 nm. The active dopant 9 may comprise holmium, and the gain peak wavelength 2317 may be in the range 1990 nm to 2150 nm. The amplifying optical device may include more than one pump. One of the pumps may emit the pump radiation at 915 nm. The other pump may emit the pump radiation at 976 nm. The active dopant 9 may comprise thulium, and the gain peak wavelength 2317 may be in the range 1900 nm to 2100 nm. The thulium ions may be pumped with a pump wavelength 2320 of 793 nm which enables so-called two-in-one pumping wherein two pump photons are associated with each photon emitted by stimulated emission.

The invention described with reference to the Figures and the Examples can be used in a variety of ways, including cleaning, paint stripping, rust removal, all of which can be made by a method which includes the steps of providing an optical fibre 10 according to the present invention, and controlling the rate of transfer of pump radiation from the second core 12 to the first core 2 using the perturbations 29. For such processes a required BPP of 20 or less might be typical.

It is to be appreciated that the embodiments of the invention described above with reference to the accompanying drawings have been given by way of example only and that modifications and additional components may be provided to enhance performance. Individual components shown in the drawings are not limited to use in their drawings and they may be used in other drawings and in all aspects of the invention. The invention also extends to the individual components mentioned and/or shown above, taken singly or in any combination.

1. An optical fibre (10) comprising at least one first core (2) and at least one second core (12), wherein:
the first core (2) comprises at least one active dopant (9);
the first core (2) and the second core (12) are separated by a first cladding (3);
the first cladding (3) has a first refractive index (5) which is less than a refractive index (4) of the first core (2) and less than a refractive index (14) of the second core (12);
the optical fibre (10) being characterized in that:
when the optical fibre (10) is configured in a straight line or with a uniform bend radius, first optical modes (101) having a first propagation constant β₁ can propagate along the second core (12) but are isolated from the active dopant (9); and
when the optical fibre (10) is subject to a perturbation (29), the first optical modes (101) can be coupled to second optical modes (102) having a second propagation constant β₂ and which overlap the active dopant (9);
thereby enabling control over at least one of a fractional inversion of the active dopant (9) along the optical fibre (10), an optical gain characteristic of the optical fibre (10), and a thermal load on the optical fibre (10), by propagating pump radiation along the second core (12) as the first optical modes (101), electively coupling the first optical modes (101) to the second optical modes (102) with one or more of the perturbations (29), and absorbing the pump radiation that has been electively coupled to the second optical modes (102) with the active dopant (9), which active dopant (9) is able to amplify by stimulated emission one or more signal modes (31) that are guided by the first core (2).

2. An optical fibre according to claim 1 wherein the perturbation (29) comprises a spatial frequency component Λ=(β₁−β₂)/2π and the perturbation (29) comprises at least one spatial frequency component that couples at least some of the first optical modes (101) together.

3. (canceled)

4. An optical fibre according to claim 1 wherein the perturbation (29) comprises spatial frequencies other than those that couple the signal modes (31) together.

5. An optical fibre according to claim 1 wherein the perturbation (29) comprises at least one of a change in bend radius, a change in bend orientation, a squeezing force, a long period grating, a change in a diameter of the optical fibre (10), a change in a cross-sectional shape of the optical fibre (10), a rotation of the optical fibre (10), and a change in material composition of the optical fibre (10) along its length.

6.-7. (canceled)

8. An optical fibre according to claim 1 wherein the second core (12) is non-circular.

9. An optical fibre according to claim 1 comprising a second cladding (12) surrounding the second core (12), wherein the second cladding (12) has a second refractive index (15) that is less the first refractive index (5).

10.-14. (canceled)

15. An optical fibre according to claim 1 wherein at least one of the first and the second cores (2), (12) is a ring core.

16.-18. (canceled)

19. An optical fibre spool (170) comprising an optical fibre (10) according to claim 1 and including a plurality of the perturbations (29).

20. An optical fibre spool (170) according to claim 19 wherein the optical fibre (10) is disposed in a groove (173).

21.-27. (canceled)

28. An amplifying optical device according to claim 1 wherein the optical fibre (10) has a fibre length that is at least twice a length of an equivalent optical fibre that has no first cladding (3) and which is optionally used with the amplifying optical device while absorbing the same amount of pump radiation along its length, wherein the first cladding (3) of the optical fibre (10) is replaced in the equivalent optical fibre by a region having the same refractive index as the refractive index (14) of the second core (12) of the optical fibre (10), thus enabling the second core (12) of the equivalent fibre to act as a pump cladding that surrounds the first core (2).

29. An amplifying optical device according to claim 28 characterized by a pulse energy, and wherein the strength and disposition of the perturbations (29) are such that when the optical fibre (10) is pumped by the pump source, the pulse energy is higher than when the amplifying optical device uses the equivalent optical fibre.

30. An amplifying optical device according to claim 28 characterized by a gain peak (2321) and a gain peak wavelength (2317), and wherein the strength and disposition of the perturbations (29) are such that when the optical fibre (10) is pumped by the pump source, the gain peak wavelength is at a longer wavelength than when the amplifying optical device uses the equivalent optical fibre, and wherein the gain peak (2321) has a higher gain when the amplifying optical device uses the optical fibre (10) than when the amplifying optical device uses the equivalent optical fibre and wherein the gain peak (2321) has a higher gain when the amplifying optical device uses the optical fibre (10) than when the amplifying optical device uses the equivalent optical fibre.

31.-38. (canceled)

39. An amplifying optical device according to claim 1 and including a seed source (231) connected to the first core (2) to allow signal energy to be guided by the first core (2) and to be amplified along the optical fibre (10), wherein the seed source (231) is a pulsed laser which is able to emit signal pulses (2319) having pulse widths between 100 ps and 10 ms, and the amplifying optical device is configured to emit individual pulse energies greater than 50 mJ, preferably greater than 100 mJ, and more preferably greater than 200 mJ.

40.-41. (canceled)

42. An amplifying optical device according to claim 1 and further comprising an optical feedback arrangement configured to promote light generation within the optical fibre (10) to produce a laser.

43. An amplifying optical device according to claim 42 and further comprising at least one reflecting device configured to reflect optical energy back into the first core (2).

44. An amplifying optical device according to claim 42 and further comprising an optical switch (2314) connected to the first core (2).

45. A method for providing optical radiation, which method comprises:
providing an optical fibre (10) comprising at least one first core (2) and at least one second core (12), wherein the first core (2) comprises at least one active dopant (9); the first core (2) and the second core (12) are separated by a first cladding (3); and the first cladding (3) has a first refractive index (5) which is less than a refractive index (4) of the first core (2) and less than a refractive index (14) of the second core (12);
propagating pump radiation along the second core (12) in the form of first optical modes (101) having a first propagation constant β₁;
selecting a strength and disposition of at least one perturbation (29);
perturbing the optical fibre (10) with the at least one perturbation (29) to couple the pump radiation from the second core (12) to second optical modes (102) having a second propagation constant β₂ and which overlap the active dopant (9);
absorbing the pump radiation with the active dopant (9);
propagating one or more signal mode (31) along the first core (2);
amplifying the signal modes (31) with the active dopant (9) by stimulated emission; and
outputting the amplified signal modes (31) in the form of the optical radiation;
the method being characterized in that:
when the optical fibre (10) is configured in a straight line or with a uniform bend radius,
the first optical modes (101) can propagate along the second core (12) but are isolated from the active dopant (9).

46. A method according to claim 45 and including the step of controlling at least one of a fractional inversion of the active dopant along the optical fibre, an optical gain characteristic of the optical fibre, and a thermal load on the optical fibre.

47. A method according to claim 45 wherein the perturbation (29) comprises a spatial frequency component Λ=(β₁−β₂)/2π and wherein the perturbation (29) comprises at least one spatial frequency component that couples at least some of the first optical modes (101) together.

48. (canceled)

49. A method according to claim 45 wherein the perturbation (29) comprises spatial frequencies other than those that couple the signal modes (31) together.

50. A method according to claim 45 wherein the perturbation (29) comprises at least one of a change in bend radius, a change in bend orientation, a squeezing force, a long period grating, a change in a diameter of the optical fibre (10), a change in a cross-sectional shape of the optical fibre (10), a rotation of the optical fibre (10), and a change in material composition of the optical fibre (10) along its length.

51. A method according to claim 45 and including the step of providing the signal modes (31) by coupling signal radiation from a seed laser into the first core (2).

52.-55. (canceled)

56. An optical fibre (10) comprising at least one first core (2) and at least one second core (12), wherein:
the first core (2) comprises at least one active dopant (9);
the first core (2) and the second core (12) are separated by a first cladding (3);
the first cladding (3) has a first refractive index (5) which is less than a refractive index (4) of the first core (2) and less than a refractive index (14) of the second core (12);
the optical fibre (10) being characterized in that:
when the optical fibre (10) is configured in a straight line or with a uniform bend radius, pump radiation can propagate along the second core (12) as first optical modes (101) without being absorbed by the active dopant (9); and
when the optical fibre (10) is subject to a perturbation (29), the pump radiation which is launched primarily into the first optical modes (101) can be electively coupled to second optical modes (102) which overlap and are absorbed by the active dopant (9), which active dopant (9) is able to amplify by stimulated emission one or more signal modes (31) that are guided by the first core (2).

57. A method for providing optical radiation, using an optical fibre comprising; at least one first core (2) and at least one second core (12), wherein:
the first core (2) comprises at least one active dopant (9);
the first core (2) and the second core (12) are separated by a first cladding (3);
the first cladding (3) has a first refractive index (5) which is less than a refractive index (4) of the first core (2) and less than a refractive index (14) of the second core (12);
the optical fibre (10) being characterized in that:
when the optical fibre (10) is configured in a straight line or with a uniform bend radius, pump radiation can propagate along the second core (12) as first optical modes (101) without being absorbed by the active dopant (9);
the method comprising:
launching pump radiation into the first optical modes; and
controlling at least one of a fractional inversion of the active dopant along the optical fibre, an optical gain characteristic of the optical fibre, and a thermal load on the optical fibre by perturbing the optical fibre along its length to electively couple the first optical modes to second optical modes (102) which overlap and are absorbed by the active dopant (9),
which active dopant (9) is able to amplify by stimulated emission one or more signal modes (31) that are guided by the first core (2).
